(19) United States
(12) Patent Application Publication
(10) Pub. No.: US 2012/0179381 A1
(43) Pub. Date: Jul. 12, 2012

(54) TOXICITY SCREENING METHODS

(76) Inventor: James M. McKim, Kalamazoo, MI (US)

(21) Appl. No.: 13/117,553

(22) Filed: May 27, 2011

Related U.S. Application Data
(60) Provisional application No. 61/355,633, filed on Jun. 17, 2010.

(51) Int. Cl. G06F 19/00

(52) U.S. Cl. 702/19

(57) ABSTRACT

In vitro methods for predicting in vivo toxicity of chemical compounds, including organ-specific and multiple organ toxicity of such chemical compounds and drug-drug interactions, understanding the relative toxicity of drug candidates and identifying mechanisms of toxicity, are disclosed.

### CROSS REFERENCE TO RELATED APPLICATIONS

This application claims benefit under 35 U.S.C. 119(e) of U.S. Ser. No. 61/355,633, filed Jun. 17, 2010. The entire contents of the above-referenced application are hereby expressly incorporated herein by reference.

### STATEMENT REGARDING FEDERALLY SPONSORED RESEARCH OR DEVELOPMENT

Not Applicable.

### FIELD OF THE INVENTION

The present application for patent relates to in vitro methods for predicting in vivo toxicity of chemical compounds, including organ-specific and multiple organ toxicity of such chemical compounds and drug-drug interactions, understanding the relative toxicity of drug candidates and identifying mechanisms of toxicity.

### BACKGROUND

The process of identifying a new drug candidate is long and tedious with many promising compounds eliminated from development during preclinical toxicity testing in animals. One reason for the high number of drop out compounds during the preclinical phase is the lack of useful toxicity data early in the discovery program. Many pharmaceutical companies have recognized this in the last several years. The time and expense associated with the drug discovery process has lead to a search for efficiencies that can be realized in the process.

To date, evaluation of in vivo toxicity of a given candidate substance as a potential drug has involved the use of animal models. Underlying the animal tests is the assumption that the effects observed in animals are applicable and predictive of effects in humans. In general, when the dosage is based on a per unit of body surface area, toxicology data from animals is applicable to humans. On the other hand, when the dosage is based on animal body weight, humans are typically more susceptible to toxicity than the test animals. Nevertheless, the vast majority of drugs are developed to be given on the basis of body weight.

Additionally, the actual numbers of animals used in drug testing are much lower than the human population likely to be exposed to the drug if the candidate is actually brought to market. For example, a 0.01% incidence of human exposure to a given drug means that approximately 25,000 out of 250 million individuals are exposed to a drug. To detect such a low incidence in animals would require that 30,000 animals be exposed to the drug. This is clearly an impractical number considering the variety of drugs in development at any given time. Consequently, exposure of fewer animals to high doses of candidate substances is desirable to identify hazards to humans exposed to low doses.

Modern drug development proceeds through a series of stages in which a vast library of compounds is gradually narrowed in a series of successive steps. The use of animals in the initial stages of drug development, in which the number of compounds still being considered is relatively large, is an expensive and inefficient method of producing toxicological data for new drugs especially in light of the fact that most chemicals this early in development, ultimately, will not be considered drug candidates. Thus, a significant need for alternative toxicological screening methods exists. Indeed, various approaches to toxicological screening prior to the animal testing stage have been proposed.

A common approach to solving the toxicology data deficit has been to incorporate in vitro toxicity testing of compounds of interest into the drug discovery process at a time when new compounds are being identified for potency and efficacy against therapeutic targets. Quality toxicity data at this early stage permits pharmaceutical chemists to attempt to “design out” toxicity while maintaining efficacy/potency. It has proved difficult, however, to develop robust in vitro toxicity testing systems that provide data that is consistently and reliably predictive of in vivo toxicity.

Key issues have been deciding on the type and nature of assays to be utilized and the test system to be employed. There are many biochemical and molecular assays that claim to assess toxicity in cells grown in culture. However, when only one or even two assays are used over a limited range of exposure concentrations, the probability of false negative and false positive data is high. Some of the most commonly used assays include, but are not limited to, leakage of intracellular markers as determined by lactate dehydrogenase (LDH), glutathione S-transferase (GST), and potassium, and the reduction of tetrazolium dyes such as MU, XTT, Alamar Blue, and INT. All have been used as indicators of cell injury. Prior art in vitro toxicity screens typically only involve the use of one or two endpoints. The resulting data provides a yes/no or live/dead answer. This minimalist approach to the toxicity-screening problem has resulted in little progress towards developing a robust screening system capable of providing a useful toxicity profile that has meaning for predicting similar toxicity in animals. Therefore, there remains a need in the art for the development of new screening systems that provide more useful toxicity information, especially toxicity information that can be obtained rapidly and cost-effectively at early stages of the drug discovery process. A need exists for toxicity screening systems that do not require the use of animals but that provide reliable information on relative toxicity, mechanism of toxicity, and that effectively predict in vivo toxicity.

The drug discovery process is often under significant time pressures, and any time lost while waiting for toxicity data can prove expensive. Thus, a need also exists for in vitro toxicity screening methods and systems optimized for providing relevant information relating to in vitro toxicity in a relatively short time frame.

In some drug development efforts, it is desirable to evaluate the toxicity potential for one or more compounds in particular organ systems. The majority of new drug candidates fail in preclinical animal studies or are withdrawn from the market due to unanticipated drug induced adverse events in liver, heart, or kidney. For this reason it would be advantageous to identify and understand the mechanisms of organ specific toxicity early in the drug development process. In order for in vitro cell-based models to accurately predict organ specific toxicity, there must be a clear link to the maximum therapeutic plasma concentration achieved or anticipated during therapy. Obtaining this information at a late stage in the process can render significant efforts and expense essentially useless. Thus, a need also exists for in vitro toxicity screening methods and systems that provide relevant information relating to in vivo toxicity in particular organ systems and functions, such as information relating to the cardio toxicity potential of a compound.

It is to such novel toxicity screening systems that the presently disclosed and claimed inventive concept(s) is directed.

### BRIEF DESCRIPTION OF THE DRAWINGS

FIG. 1 is a graphical representation depicting multiple locations in the nephron at which kidney injury can occur.

FIG. 2 depicts a diagrammatic representation of the human renal proximal tubule cell and transporter locations therein.

FIG. 3 illustrates a transwell culture system for human renal proximal tubule cells constructed in accordance with the presently disclosed and claimed inventive concept(s), wherein said system provides a two compartment model.

FIG. 4 graphically depicts a comparison of OCT2 transport activity in porcine and human proximal tubule cells.

FIG. 5 graphically depicts one embodiment of a proposed plate organization for a Renal-Specific-Toxicity (RST) Model Acute-RST Test constructed in accordance with the presently disclosed and claimed inventive concept(s).

FIG. 6 graphically illustrates cell dependent sensitivity to cisplatin toxicity.

FIG. 7 graphically depicts a method of predicting renal specific toxicity in accordance with the presently disclosed and claimed inventive concept(s).

FIG. 8 diagrammatically represents a cellular model utilized in a liver specific toxicity screen of the presently disclosed and claimed inventive concept(s).

FIG. 9 depicts incorporation of in vitro toxicity assays into the discovery pipe line.

FIG. 10 diagrammatically represents primary hepatocytes in culture versus a hepatoma cell line.

FIG. 11 graphically depicts ANIT decreased glutathione, disrupted mitochondria, increased oxidative stress, and damaged canalicular membrane integrity.

FIG. 12 graphically illustrates that a comparison of three non-tricyclic antidepressants identified nefazodone as greatest risk.

FIG. 13 graphically depicts one embodiment of proposed plate organizations for a multiple organ toxicity screen constructed in accordance with the presently disclosed and claimed inventive concept(s).

### DETAILED DESCRIPTION OF EXEMPLARY EMBODIMENTS

The following detailed description and appendices describe and illustrate various exemplary embodiments. The description and drawings serve to enable one skilled in the art to make and use the invention, and are not intended to limit the scope of the invention in any manner.

Relevant background information is available in the following US patents: U.S. Pat. No. 6,998,249 issued to McKim and Cockerell on Feb. 14, 2006; and U.S. Pat. No. 7,615,361, issued to McKim on Nov. 11, 2009. The entire contents of each of the above-referenced patents are expressly incorporated into this disclosure.

Before explaining at least one embodiment of the invention in detail by way of exemplary drawings, experimentation, results, and laboratory procedures, it is to be understood that the invention is not limited in its application to the details of construction and the arrangement of the components set forth in the following description or illustrated in the drawings, experimentation and/or results. The invention is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the presently disclosed and claimed inventive concept(s) shall have the meanings that are commonly understood by those of ordinary skill in the art. Further, unless otherwise required by context, singular terms shall include pluralities and plural terms shall include the singular. Generally, nomenclatures utilized in connection with, and techniques of, cell and tissue culture, molecular biology, and protein and oligo- or polynucleotide chemistry and hybridization described herein are those well known and commonly used in the art. Standard techniques are used for recombinant DNA, oligonucleotide synthesis, and tissue culture and transformation (e.g., electroporation, lipofection). Enzymatic reactions and purification techniques are performed according to manufacturer's specifications or as commonly accomplished in the art or as described herein. The foregoing techniques and procedures are generally performed according to conventional methods well known in the art and as described in various general and more specific references that are cited and discussed throughout the present specification. See e.g., Sambrook et al. Molecular Cloning: A Laboratory Manual (2nd ed., Cold Spring Harbor Laboratory Press, Cold Spring Harbor, N.Y. (1989) and Coligan et al. Current Protocols in Immunology (Current Protocols, Wiley Interscience (1994)), which are incorporated herein by reference. The nomenclatures utilized in connection with, and the laboratory procedures and techniques of, analytical chemistry, synthetic organic chemistry, and medicinal and pharmaceutical chemistry described herein are those well known and commonly used in the art. Standard techniques are used for chemical syntheses, chemical analyses, pharmaceutical preparation, formulation, and delivery, and treatment of patients.

All publications and patent applications mentioned in the specification are indicative of the level of skill of those skilled in the art to which the presently disclosed and claimed inventive concept(s) pertains. All publications and patent applications are herein incorporated by reference to the same extent as if each individual publication or patent application was specifically and individually indicated to be incorporated by reference.

All of the compositions and/or methods disclosed and claimed herein can be made and executed without undue experimentation in light of the present disclosure. While the compositions and methods of the presently disclosed and claimed inventive concept(s) have been described in terms of preferred embodiments, it will be apparent to those of skill in the art that variations may be applied to the compositions and/or methods and in the steps or in the sequence of steps of the method described herein without departing from the concept, spirit and scope of the inventive concept(s). All such similar substitutes and modifications apparent to those skilled in the art are deemed to be within the spirit, scope and concept of the inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results.

The term “about” is used to indicate that a value includes the inherent variation of error for the device, the method being employed to determine the value and/or the variation that exists among study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

The terms “TC₅₀”, “IC₅₀” and “EC₅₀” may be used herein interchangeably, and will be understood to refer to an exposure concentration in vitro that produces a half maximal effect for toxicity.

The development of new drugs from concept to market requires nearly 1 billion dollars and more than 15 years to accomplish. Unfortunately, many promising new candidates are dropped from development due to unanticipated adverse effects discovered during preclinical animal safety studies or in clinical trials. In vitro or cell based models can be used to identify toxicity early in the development process. A current unmet need in the pharmaceutical industry is an in vitro model that can provide information on organ specific toxicity and identify those drugs that will cause idiosyncratic toxicity once in the market. Most drugs cause their adverse effects in the heart, liver, or kidney. Therefore, an in vitro model that could identify not only that a compound is toxic, but also that it is toxic to a specific organ, is desired. It is not possible to predict liver toxicity by simply added test compound to a liver cell. Specificity in the cell models comes first by selecting tissue correct cell models and second by selecting endpoints of cell health that are unique to the organ. A key component to building in vitro models that predict in vivo toxicity is to link the in vitro effects to an in vivo anchor. This is necessary in order for the in vitro data to have meaning in terms of predicting the risk of an adverse event occurring in animals or in humans.

The presently disclosed and claimed inventive concept(s) utilizes a unique combination of data with the use of cells from liver and kidney. This method identifies the organ with highest probability of developing toxicity, relates actual therapeutic exposures to these effects, and provides of means of flagging compounds with low toxicity in animals and short term human clinical studies, but which carry a risk profile for causing unanticipated toxicity in humans after the drug has entered the market. The method provides a means of assessing risk for organ specific toxicity based on a relationship between the mean therapeutic plasma concentration and the exposure concentration in vitro that produces a half maximal effect (TC₅₀) for toxicity. The methods of the presently disclosed and claimed inventive concept(s) provide a means of determining organ specificity and then relating that effect to an expected plasma concentration.

I. Methods of Determining/Predicting Renal Specific Toxicity

In one embodiment, the presently disclosed and claimed inventive concept(s) is directed to a method of assessing risk for renal specific toxicity of a chemical compound. In the method, three TC₅₀ (concentrations of the chemical compound that produce a half maximal toxic effect) values for the chemical compound are determined: (1) a TC_{50 specific renal} for at least one indicator of renal specific cell health in freshly isolated mammalian proximal tubule cells; (2) a TC_{50 general renal} for at least one general indicator of cell health in freshly isolated mammalian proximal tubule cells; and (3) a TC_{50 hepatic} for the same general indicator of cell health as in (2), but determined in freshly isolated liver cells. A mean TC_{50 renal} is then calculated from the TC_{50 specific renal} and TC_{50 general renal} values. A toxicity index (TI) is then calculated as the as the ratio of the mean TC_{50 renal} over the TC_{50 hepatic}, wherein when the TI is equal to 1.0, there is no organ specificity, when the TI is <1.0, the indication is renal toxicity, and when the TI is >1.0, the indication is liver toxicity.

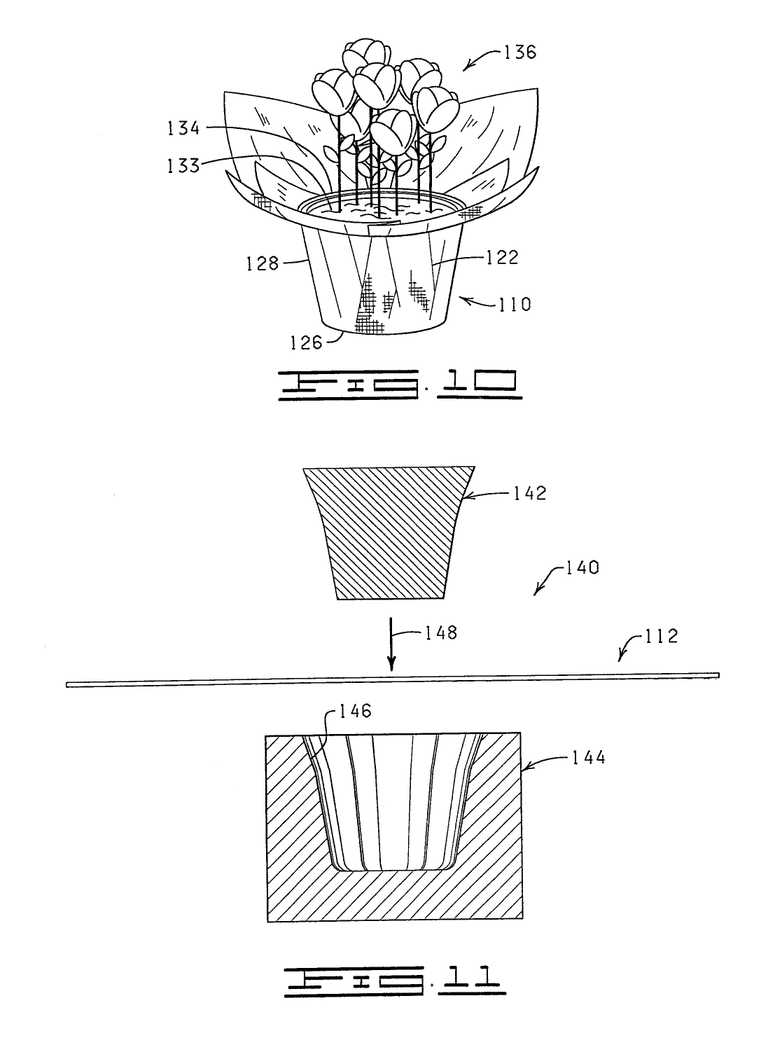

The method may further include the step of comparing the TI to a database of chemical compounds that have known levels of renal toxicity. In said method, a database of drugs with varying renal toxic potencies is utilized to assess data for a chemical compound of unknown toxicity (wherein the data is obtained as described herein above). Maximum therapeutic plasma concentrations (Cₘₐₓ) are compared to renal specific markers and the concentration that produces half maximal toxicity (EC₅₀ or TC₅₀). Renal specific toxicity is then predicted based on the chart shown in FIG. 7. Note that as Cₘₐₓ or plasma concentration exceeds the EC₅₀ of the indicator of renal specific cell health (referred to as “Renal tox marker” in FIG. 7), the probability of toxicity increases.

In addition, the method may yet further include the step of comparing at least one of TC_{50 specific renal}, TC_{50 general renal}, and mean TC_{50 renal} to a No Observed Effect Level (NOAEL), and a maximum therapeutic concentration (Cₘₐₓ) for the chemical compound. In this manner, a probability of toxicity increases as mean TC_{50 renal} approaches Cₘₐₓ.

In addition, as the Cₘₐₓ approaches a concentration that falls within the boundary between the NOAEL (lower limit of boundary) and the mean TC_{50 renal} (upper limit of boundary), the probability of toxicity increases. Yet further, the probability of toxicity can also be determined by performing a quadrant analysis using a chart like the one provided in FIG. 7, as described in more detail herein below. The database allows for a three dimensional scatter plot of many known drugs with known renal toxicity to be plotted with their plasma concentration data. The quadrants formed provide a good indication of renal toxicity in humans.

The TC_{50 specific renal} value may be calculated by any method known in the art or otherwise contemplated within the scope of the presently disclosed and claimed inventive concept. In one embodiment, the method utilizes freshly isolated mammalian proximal tubule cells that are cultured under conditions that allow said cells to establish polarity and basolateral and apical sidedness. In certain embodiments, the mammalian proximal tubule cells may be specific to the species in which the toxicity determination is required. For example, for determining human renal toxicity, a primary culture of human proximal tubule epithelial cells (hRPTCs) may be utilized; for rabbit renal toxicity, the rabbit proximal tubule cell line LLCPK1 may be utilized; and for canine renal toxicity, the dog cell line MDCK may be utilized. However, it is to be understood that the presently disclosed and claimed inventive concept(s) is not limited to the use of cells specific to the species in which the toxicity determination is required; for example, human cells may also predict animal effects, provided the animal possesses the same biochemical pathways and potential toxicity targets as humans.

The freshly isolated mammalian proximal tubule cells are cultured in the presence of a plurality of concentrations of said chemical compound. The chemical compound may be exposed to the apical and/or basolateral side of the cells. At least one indicator of renal specific cell health (i.e., renal specific marker of toxicity) is measured at the plurality of concentrations of said chemical compound for the proximal tubule cells. Said indicators of renal specific cell health include, but are not limited to, Neutrophil gelatinase associated lipocalin (also referred to as NGAL, LPN2 and Lpn2), Kidney injury marker-1 (KIM1), clusterin, as well as other markers directed to uptake mechanisms and pharmacokinetics.

A concentration response analysis is then performed for the at least one indicator of renal specific cell health from the measurements obtained at the plurality of concentrations of the chemical compound. The highest concentration of said chemical compound at which no measurable toxic effect was observed for the at least one indicator of renal specific cell health is then identified from the concentration response analyses. Then a renal specific toxic concentration can be selected as a concentration less than or equal to the highest concentration of said chemical compound at which no measurable toxic effect was observed for the at least one indicator of renal specific cell health. In particular, a concentration that produces a half maximal toxic effect (TC_{50 specific renal}) is determined for the at least one indicator of renal specific cell health.

The use of at least one NGAL assay in the in vitro assay of the presently disclosed and claimed inventive concept(s) is novel and unexpected over the knowledge in the prior art regarding NGAL protein and mRNA levels in vivo. In animals, an increase in plasma NGAL or urine NGAL indicates renal toxicity; however, this process is reversed in vitro. Therefore, for this in vitro assay, normal cells are known to secrete NGAL into the culture medium, and therefore levels of at least one of secreted NGAL protein and NGAL mRNA are detected in this in vitro assay; unhealthy cells are indicated by a reduction in secretion of NGAL as well as an increase in mRNA expression of NGAL.

In a similar manner, when clusterin is utilized as an indicator of renal specific cell health, levels of at least one of secreted clusterin protein and clusterin mRNA are detected; secretion of clusterin decreases in the presence of renal toxicity, while clusterin mRNA expression increases in the presence of renal toxicity.

When KIM1 is utilized as an indicator of renal specific cell health, the assay may include at least one of a measurement of secretion thereof into cell culture and a measurement of mRNA levels; both secretion and mRNA expression of KIM1 increase in the presence of renal toxicity.

In addition, the use of the combination of monitoring both protein and mRNA expression of target levels is novel, and therefore the presently disclosed and claimed inventive concept(s) is also directed to a method of determining if a chemical compound exhibits renal toxicity that includes said measurements. In said method, freshly isolated renal proximal tubule cells are provided and cultured in the presence of one or more concentrations of said chemical compound. Two indicators of cell health are measured at the one or more concentrations of said chemical compound, and said two indicators of cell health include (1) an assay of levels of a target protein; and (2) an assay of mRNA expression levels for said target protein. The target protein may be selected from the group consisting of NGAL, clusterin and KIM1. When NGAL or clusterin is utilized, it is determined that the chemical compound exhibits renal toxicity if a reduction in NGAL/clusterin protein secretion and an increase in NGAL/clusterin mRNA expression is observed in cells cultured in the presence of one or more concentrations of said chemical compound compared to cells cultured in the absence of the chemical compound. When KIM is utilized, it is determined that the chemical compound exhibits renal toxicity if an increase in KIM protein secretion and KIM mRNA expression is observed in cells cultured in the presence of one or more concentrations of said chemical compound compared to cells cultured in the absence of the chemical compound.

In addition, the scope of the presently disclosed or claimed inventive concept(s) also encompasses the use of two or more (i.e., a plurality of) indicators of renal specific cell health as described herein above. When multiple indicators of renal specific cell health are used, the renal specific toxic concentration identified above is the highest concentration of said chemical compound at which no measurable toxic effect was observed for all of the indicators of renal specific cell health measured. In addition, a concentration that produces a half maximal toxic effect (TC_{50 renal}) may be determined for each of the indicators of renal specific cell health.

While the use of freshly isolated proximal tubule cells is described herein above, it is to be understood that the presently disclosed and claimed inventive concept(s) is not limited to use of said primary cells. Rather, the presently disclosed and claimed inventive concept(s) also contemplates the use of cell lines as well as renal tissue slices. In addition, the cells may be cultured in monolayer or in transwell culture plates.

The TC_{50 general renal} and IC_{50 general hepatic} values may be calculated by any method known in the art or otherwise contemplated within the scope of the presently disclosed and claimed inventive concept. The general and/or nonspecific markers of cell health that may be utilized in accordance with the presently disclosed and claimed inventive concept(s) include, but are not limited to, indicators of cell membrane integrity (i.e., GGT, AP, ALT, AST, LDH, GST, and the like); indicators of oxidative stress (i.e., DCFDA); indicators of cell mortality (i.e., an apoptosis assay such as caspase 3, 8, 9; BAX/Bcl2 ratio; and the like); indicators of mitochondrial function (i.e., MTT, ATP, and the like); indicators of cell proliferation (i.e., BrdU and the like); indicators of lysosomal toxicity; and combinations thereof. Detailed descriptions of indicators of cell health and use thereof in accordance with the presently disclosed and claimed inventive concept(s) are provided in the inventor's U.S. Pat. Nos. 6,998,249 and 7,615,361, previously incorporated herein by reference. In addition, further information regarding said assays can be found below in Section (IV).

In one embodiment, the TC_{50 general renal} an are calculated and TC_{50 general hepatic} values as follows. Freshly isolated renal proximal tubule cells (cultured as described herein above so that they establish polarity and basolateral apical sidedness) and freshly isolated liver cells are provided and cultured separately in the presence of a plurality of concentrations of said chemical compound. Then at least one indicator of cell health is measured at four or more concentrations of said chemical compound for the renal proximal tubule cells as well as for the liver cells, wherein the at least one indicator of cell health measured in both cell types is the same. A level of toxicity of the chemical compound is then determined from these measurements by the following steps: (a) performing a concentration response analysis for each indicator of cell health from the measurements taken for the proximal tubule cells; (b) performing a concentration response analysis for each indicator of cell health from the measurements taken for the liver cells; (c) identifying, from the concentration response analysis of (a), the highest concentration of said chemical compound at which no measurable toxic effect was observed for each measured indicator of cell health for the proximal tubule cells; (d) identifying, from the concentration response analysis of (b), the highest concentration of said chemical compound at which no measurable toxic effect was observed for each measured indicator of cell health for the liver cells; (e) determining a concentration that produces a half maximal toxic effect (TC_{50 general renal}) for the measured indicator(s) of cell health for the proximal tubule cells; and (f) determining a concentration that produces a half maximal toxic effect (IC_{50 general hepatic}) for the measured indicator(s) of cell health for the liver cells.

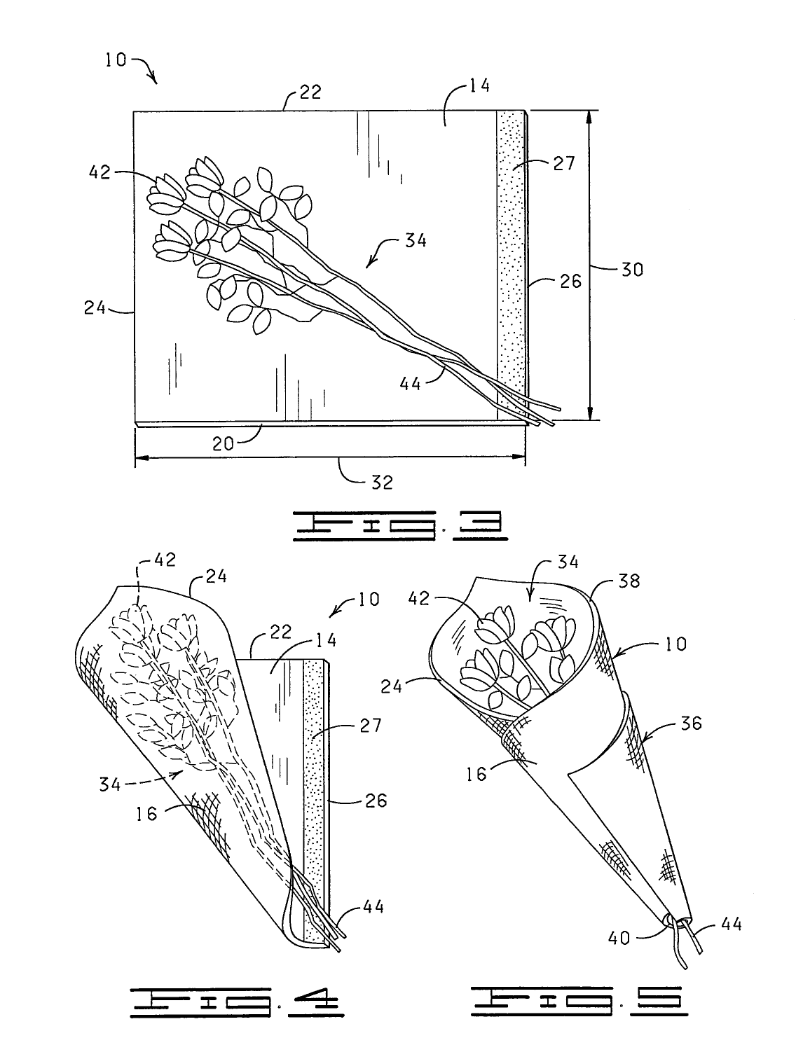

In another embodiment of the presently disclosed and claimed inventive concept(s), the TC_{50 specific renal} value is calculated by the following method that measures interaction or inhibition of transporter activity. Said method may be combined with any of the other methods described herein, or may be utilized alone. Human renal proximal tubule epithelial cells (hRPTEC) purchased commercially possess functional transporters which are key to predicting renal toxicity in humans. hRPTEC grown on a transwell plate polarize and function with an apical (lumen) and basal side orientation, thus providing a more in-vivo like structure (see FIGS. 2 and 3). In said method, freshly isolated mammalian proximal tubule cells are provided and cultured in a manner that allows said cells to polarize and thus possess apical and basal sides. The cells are then cultured in the presence of said chemical compound, wherein said chemical compound is exposed to the apical side of the cells, the basal side of the cells, or both. At least one measurement is then determined, wherein the measurement is selected from the group consisting of: (1) whether the chemical compound is a substrate for at least one uptake transporter; (2) whether the chemical compound binds to and alters the normal function of at least one transporter; and (3) whether the chemical compound disrupts the normal interaction of at least one transporter with a second, co-administered chemical compound. The transport may be selected from the group consisting of Na⁺, K⁺-ATPase pumps, organic anion transporters (OAT's, such as but not limited to, OAT4 and OATS), sodium/phosphate transporter type I (NPT1), multi-drug resistance associated proteins (MRP's, such as but not limited to, MRP2 and MRP4), multi-drug resistance protein 1 (MDR1), organic cation family (OCT), solute carrier family of proteins (such as but not limited to, PepT1), and combinations thereof.

The data obtained from the method above may be combined with data above in any of the methods described herein above that assess renal specific toxicity and/or normal cellular biochemical functions. Said toxicity data can then be compared to the database described herein above containing drugs that have known renal liabilities. In this manner, maximal therapeutic plasma concentrations may be estimated to develop a final risk profile.

II. Methods of Determining/Predicting Liver Specific Toxicity

The presently disclosed and claimed inventive concept(s) is also directed to a method of assessing risk for hepatic specific toxicity of a chemical compound. As the liver is the first organ of exposure, the anchor organ, it is important in understanding if toxicity will occur. In the method, a concentration of the chemical compound that produces a half maximal toxic effect (TC_{50 specific hepatic}) for at least one indicator of hepatic specific cell health is determined, and a concentration of the chemical compound that produces a half maximal toxic effect (TC_{50 general hepatic}) for at least one general indicator of cell health is determined. Both measurements are obtained in freshly isolated mammalian primary hepatocytes and/or a specific hepatoma cell line. Then the calculated TC_{50 specific hepatic} and TC_{50 general hepatic} values are compared, wherein if TC_{50 specific hepatic} is less than TC_{50 general hepatic}, the indication is hepatic toxicity.

The method may further include a comparison of at least one of the TC_{50 specific hepatic} and TC_{50 general hepatic} values to a maximum therapeutic plasma concentration (Cₘₐₓ) for the chemical compound. In addition, the method may also include a comparison of at least one of the TC_{50 specific hepatic} and TC_{50 general hepatic} values to a database of chemical compounds that have known levels of hepatic toxicity.

The TC_{50 specific hepatic} and TC_{50 general hepatic} values may be calculated by any method known in the art or otherwise contemplated within the scope of the presently disclosed and claimed inventive concept. In one embodiment the TC_{50 specific hepatic} and TC_{50 general hepatic} values may be calculated by a method that includes providing freshly isolated mammalian primary hepatocytes and/or specific hepatoma cell lines. Said primary hepatocytes may be specific to the species in which the toxicity determination is required; for example but not by way of limitation, the primary hepatocytes may be obtained from rat, dog, monkey or human. In particular, the H4IIE cell line may be utilized for rat studies, and the HepG2 cell line may be utilized for human studies. However, it is to be understood that the presently disclosed and claimed inventive concept(s) is not limited to the use of cells specific to the species in which the toxicity determination is required; for example, human cells may also predict animal effects, provided the animal possesses the same biochemical pathways and potential toxicity targets as humans.

Said cells are then cultured in the presence of a plurality of concentrations of the chemical compound, and at least one indicator of hepatic specific cell health and at least one indicator of general cell health are measured at the plurality of concentrations of said chemical compound. The indicator(s) of hepatic specific cell health may be selected from the group consisting of: (a) liver specific endpoints for cholestasis (including, but not limited to, BSEP, UGT1A1, GGT); (b) biochemical markers for cell health (including, but not limited to, mitochondrial function (i.e., ATP, MTT, JC-1); membrane integrity; apoptosis (i.e., caspase 3); oxidative stress (i.e., GSH levels); GST leakage; (c) lysosomal stress (lipidosis) (including, but not limited to, Nile red assay); (d) key metabolic components (including but not limited to, CYP1A, 3A and 4A expression levels); and (e) normal hepatic metabolic functions including glycolysis, gluconeogenesis, lipogenesis and fatty acid oxidation (i.e., PEPCK1 and 2 and glucose-6-phosphate levels; PPAR alpha binding CAR receptor expression and activation; CYP2B induction). It is further noted that GGT and alkaline phosphatase (AP) are specific markers for canalicular damage in liver. These markers provide unique predictive power related to bile duct damage.

The indicator(s) of general cell health may be selected from the group consisting of indicators of cell membrane integrity (i.e., GGT, AP (alkaline phosphatase), ALT, AST, LDH, GST, and the like); indicators of oxidative stress (i.e., DCFDA); indicators of cell mortality (i.e., an apoptosis assay such as caspase 3, 8, 9; BAX/Bcl2 ratio; and the like); and indicators of mitochondrial function. Detailed descriptions of indicators of cell health and use thereof in accordance with the presently disclosed and claimed inventive concept(s) are provided in the inventor's U.S. Pat. Nos. 6,998,249 and 7,615,361, previously incorporated herein by reference. In addition, further information regarding said assays can be found below in Section (IV).

Concentration response analyses are then performed for each indicator of hepatic specific cell health and for each indicator of general cell health from the measurements obtained at the plurality of concentrations of the chemical compound. From the concentration analyses, the highest concentration of said chemical compound at which no measurable toxic effect was observed for each of the indicators is determined. Then a concentration that produces a half maximal toxic effect (TC_{50 specific hepatic}) for the indicator(s) of hepatic specific cell health is determined, and a concentration that produces a half maximal toxic effect (TC_{50 general hepatic}) for the indicator(s) of general cell health is determined. These values can then be compared to the maximum therapeutic plasma concentration achieved in the clinic to determine risk to humans.

In addition, the presently disclosed and claimed inventive concept(s) also includes a method of predicting hepatic toxicity in which a database of drugs with varying hepatic toxic potencies is utilized to assess data for a chemical compound of unknown toxicity (wherein the data is obtained as described herein above). This database may be constructed and utilized in the same manner as described herein above in Section (I) for the method of predicting renal toxicity, and as illustrated in FIG. 7.

By evaluating multiple endpoints that encompass all major areas of liver function, it is possible to determine whether a new drug or chemical will produce liver toxicity. More importantly the method can identify the type of liver damage (when multiple indicators of hepatic cell health are utilized).

III. Methods of Screening Multiple Organs for Specific Organ Toxicities

The presently disclosed and claimed inventive concept(s) further includes a method of screening a chemical compound for specific toxicity in multiple organs. In said method, a two cell model, organ specific toxicity endpoints, and markers of general cell health are incorporated so that it is possible to identify a drug's potential to cause liver, heart, and/or kidney toxicity.

In this method, TC₅₀ values for specific organs are determined (as described in detail herein above in Sections (I) and (II)), and then compared to one another. For example, a renal TC₅₀ value (i.e., TC_{50 renal}) may be calculated as described herein above in Section (I), 1, whereas a hepatic TC₅₀ value (i.e., TC_{50 hepatic}) may be calculated as described herein above in Section (II). These values may be compared to one another or to a TC₅₀ value of a third organ, such as but not limited to, heart TC₅₀ (i.e., TC_{50 cardiac} or TC_{50 CM}). U.S. Pat. No. 7,615,361, issued to the inventor and previously incorporated herein by reference, discloses and claims a method of obtaining a TC_{50 cardiac} value.

Upon obtaining at least two TC₅₀ values, organ specificity is determined by calculating the ratio of two TC₅₀ values (TC_{50 organ A}/TC_{50 organ B}); the resulting ratio is the toxicity index (TI). When the ratio approaches 1.0, there is no organ specificity. When the TI is less than 1.0, specificity is toward the organ in the numerator of the ratio (organ A). If the TI is greater than 1.0, the specificity is for the organ in the denominator of the ratio (organ B).

In one embodiment, three TC₅₀ values are compared. Two ratios are obtained, and one TC₅₀ value is utilized as the denominator in both ratios. That is, TC_{50 organ a}, TC_{50 organ b} and TC_{50 organ c} are provided, and two ratios are compared:

TI₁=TC_{50 organ a}/TC_{50 organ c} TI₂=TC_{50 organ b}/TC_{50 organ c}

When the ratio(s) TI₁ and/or TI₂ approaches 1.0, there is no organ specificity. When TI₁ and/or TI₂ is less than 1.0, specificity is toward the organ in the numerator (i.e., “organ a” or “organ b”, respectively). If TI₁ and/or TI₂ is greater than 1.0, the specificity is for “organ c”.

IV. Further Information Regarding Measurements of General and Nonspecific Markers of Cell Health that May be Included in the Methods of Sections (I)-(III)

The presently disclosed and claimed inventive concept(s) may further include a cluster analysis in which two or more different biochemical endpoints are evaluated in order to predict the in vivo toxicity concentration of a given compound, prioritize compounds based on relative toxicity, and/or identify mechanisms of toxicity. In certain embodiments, these assays measure changes in specific biochemical processes, which are essential for normal cellular functions, following a 24-hour exposure to a broad range of concentrations of the compound. In certain other embodiments, these assays may be measured following both a 6-hour exposure and a 24-hour exposure to a broad range of concentrations of the compound.

The toxicity cluster analyses of the presently disclosed and claimed inventive concept(s) allow the determination of appropriate information relating to changes occurring in specific cellular processes. This information in turn is used to obtain a more complete profile of cellular injury and/or cytotoxicity. Further, the analyses described herein may be utilized to identify specific types of toxicity, including but not limited to, toxicity to certain organs as well as multiple organ toxicity.

Cluster Analysis Toxicity Screening: In the presently disclosed and claimed inventive concept(s), cluster analysis toxicity screening is presented as a method of predicting the in vivo toxicity of a given compound. In particular aspects, these assays will involve culturing cells in culture medium that comprises a plurality of concentrations of the chemical compound; measuring a plurality of cell health indicators of the cell in response to culturing in at least three concentrations of the chemical compound and predicting TC₅₀ and a toxic concentration (Cₜₒₓ) of the chemical compound from such measurements. The various embodiments involved in conducting such assays are described in further detail below.

Assay Format: In certain embodiments, the CATS technique will be used to prioritize and identify compounds that will be of a potential therapeutic value. The inventors have discovered that analyzing multiple endpoints yields significant information regarding the toxicity of a given compound.

In certain embodiments, the presently disclosed and claimed inventive concept(s) concerns a method for identifying such compounds. It is contemplated that this screening technique will prove useful in the general prioritization and identification of compounds that will serve as lead therapeutic compounds for drug development. The invention will be a useful addition to laboratory analyses directed at identifying new and useful compounds for the intervention of a variety of diseases and disorders including, but not limited to, Alzheimer's disease, other disorders and diseases of the central nervous system, metabolic disorders and diseases, cancers, diabetes, depression, immunodeficiency diseases and disorders, immunological diseases and disorders, autoimmune diseases and disorders, gastrointestinal diseases and disorders, cardiovascular diseases and disorders, inflammatory diseases and disorders, and infectious diseases, such as a microbial, viral or fungal infections.

In specific embodiments, the presently disclosed and claimed inventive concept(s) is directed to a method for determining the in vivo cytotoxicity of a candidate substance by employing a method including generally: a) culturing cells in culture medium that comprises a plurality of concentrations of said chemical compound; b) measuring a first indicator of cell health at four or more concentrations of said chemical compound; c) measuring a second indicator of cell health at four or more concentrations of said chemical compound; d) measuring a third indicator of cell health at four or more concentrations of said chemical compound; and e) predicting a toxic concentration (Cₜₒₓ) of said chemical compound from the measurements of steps (b), (c) and (d).

In certain aspects, the method may further involve predicting a TC₅₀ of said chemical compound from the measurements of steps (b), (c) and (d). For any particular assay, the TC₅₀ represents the concentration of a compound which causes fifty percent of a maximal toxic response in the assay. As described in greater detail below, when CATS is run under certain conditions, TC₅₀ can be selected as a predicted Cₜₒₓ.

The foregoing method requires preparing cell cultures. Such a cell may be a primary cell in culture or it may be a cell line. The cells may be obtained from any mammalian source that is amenable to primary culture and/or adaptation into cell lines. In lieu of generating cell lines from animals, such cell lines may be obtained from, for example, American Type Culture Collection, (ATCC, Rockville, Md.), or any other Budapest treaty or other biological depository. The cells used in the assays may be from an animal source or may be recombinant cells tailored to express a particular characteristic of, for example, a particular disorder for which the drug development is being considered. In one embodiment, the cells are derived from tissue obtained from humans or other primates, rats, mice, rabbits, sheep, dogs and the like. Techniques employed in mammalian primary cell culture and cell line cultures are well known to those of skill in that art. Indeed, in the case of commercially available cell lines, such cell lines are generally sold accompanied by specific directions of growth, media and conditions that are preferred for that given cell line.

The presently disclosed and claimed inventive concept(s) may predict the cytotoxicity of a given compound by measuring two or more indicators of cell health in a given cell. The cell chosen for such an endeavor will depend on the putative site of in vivo toxicity to be determined. For example, the liver is a particularly prevalent site of in vivo drug toxicity. Thus, the use of liver cells (either primary or cell lines derived from liver cells) in the assays described herein is specifically contemplated. In certain embodiments, the inventors have found that the H4IIE cell line (ATCC #CRL-1548) is an excellent candidate for predicting the cytotoxic effects of compounds on the general health of hepatic cells. In addition, because the H4IIE cell line is a proliferating cell population, the system will be useful in identifying compounds that adversely affect other proliferating cell types such as hematopoietic cells. Such cells can be used to identify chemotherapeutic agents that have extremely low hepatotoxicity but high toxicity to proliferating cells. (See Example 5 of U.S. Pat. No. 6,998,249, issued to McKim et al. on Feb. 14, 2006, the contents of which have been incorporated herein previously).

While the H4IIE cell line is described herein as a particularly contemplated cell line, it should be understood that any mammalian primary hepatic cell or hepatic cell line will be useful in the presently disclosed and claimed inventive concept(s). In certain embodiments, the cell is a rat hepatic cell line. In addition to H4IIE, other rat cell lines contemplated for use in the presently disclosed and claimed inventive concept(s) include, but are not limited to MH1C1 (ATCC CCL144), clone 9 (ATCC CRL-1439), BRL 3A (ATCC CRL-1442), H4TG (ATCC CRL-1578), H4IIEC3 (ATCC CRL-166), McA-RH7777 (ATCC CRL-1601) McA-RH8994 (ATCC CRL-1602), N1-S1 Fudr (ATCC CRL-1603) and N1-S1 (ATCC CRL-1604).

In other embodiments, the cell is a human liver cell. A human hepatic cell line acceptable for use in the methods described by the presently disclosed and claimed inventive concept(s) is HepG2 (ATCC HB-8065). Additionally, other exemplary human hepatic cell lines that may be useful in the presently disclosed and claimed inventive concept(s) include but are not limited to C3A (ATCC CRL-10741), DMS (ATCC CRL-2064), SNU-398 (ATCC CRL-2233), SNU-449 (ATCC CRL-2234), SNU-182 (ATCC CRL-2235), SNU-475 (ATCC CRL2236), SNU-387 (ATCC CRL-2237), SNU-423 (ATCC CRL-2238), NC1-H630 (ATCC CRL-5833), NC1-H1755 (ATCC CRL-5892), PLC/PRF/5 (ATCC CRL8024), Hep3B (HB-8064) and HTB-52 (ATCC HTB-52).

In another embodiment, the presently disclosed and claimed inventive concept(s) may include performing such methods with more than one cell type to determine multiple organ toxicity of a compound. While the above cells will be useful indicators of hepatic cell toxicity, the presently disclosed and claimed inventive concept(s) may be employed to determine, monitor or otherwise predict cytotoxicity in a variety of tissue types. It should be understood that the in vivo sites of cellular toxicity that those of skill in the art will want to monitor will include the in vivo sites of action of the particular test compound as well as sites remote from the site of action of the test compound. Therefore, cell lines that may be used in assays will include cell lines derived from other common sites of in vivo cytotoxicity such as the kidney, heart and pancreas. While these tissues, along with the liver, may be the primary tissues that one would select to monitor cytotoxicity, it should be understood that the assays of the presently disclosed and claimed inventive concept(s) may be employed to predict the cytotoxic effects of a test compound on cells derived from brain, nerve, skin, lung, spleen, endometrial, stomach and breast tissue, as well as stem cells and hematopoietic cells. Use of hematopoietic cells or “stem” cells or cell lines derived therefrom in cytotoxicity assays is particularly contemplated.

In particular embodiments, the cells are seeded in multiwell (e.g., 96-well) plates and allowed to reach log phase growth.

Once the cell cultures are thus established, various concentrations of the compound being tested are added to the media, and the cells are allowed to grow exposed to the various concentrations for a period of time, such as 24 hours. While the 24 hour exposure period is described, it should be noted that this is merely an exemplary time of exposure, and testing the specific compounds for longer or shorter periods of time is contemplated to be within the scope of the invention. As such it is contemplated that the cells may be exposed to the test compound for 6, 12, 24, 36, 48 or more hours. Increased culture times may sometimes reveal additional cytotoxicity information, at the cost of slowing down the screening process.

Furthermore, the cells may be exposed to the test compound at any given phase in the growth cycle. For example, in some embodiments, it may be desirable to contact the cells with the compound at the same time as a new cell culture is initiated. Alternatively, it may be desirable to add the compound when the cells have reached confluent growth or arc in log growth phase. Determining the particular growth phase cells are in is achieved through methods well known to those of skill in the art.

The varying concentrations of the given test compound are selected with the goal of including some concentrations at which no toxic effect is observed and also at least two or more higher concentrations at which a toxic effect is observed. A further consideration is to run the assays at concentrations of a compound that can be achieved in vivo. For example, assaying several concentrations within the range from 0 micromolar to about 300 micromolar is commonly useful to achieve these goals. It will be possible or even desirable to conduct certain of these assays (as well as any of the assays described herein) at concentrations higher than 300 micromolar, such as, for example, 350 micromolar, 400 micromolar, 450 micromolar, 500 micromolar, 600 micromolar, 700 micromolar, 800 micromolar, 900 micromolar, or even at millimolar concentrations. The estimated therapeutically effective concentration of a compound provides initial guidance as to upper ranges of concentrations to test. Additionally, as explained in greater detail below, CATS analysis may further include assaying a range of concentrations that includes at least two concentrations at which cytotoxicity is observable in an assay. It has been found that assaying a range of concentrations as high as 300 micromolar often satisfies this criterion.

In an exemplary set of assays, the test compound concentration range under which the CATS is conducted (and which also apply to any of the methods described and claimed herein) comprises dosing solutions which yield final growth media concentration of 0.05 micromolar, 0.1 micromolar, 1.0 micromolar, 5.0 micromolar, 10.0 micromolar, 20.0 micromolar, 50.0 micromolar, 100 micromolar, and 300 micromolar of the compound in culture media. As mentioned, these are exemplary ranges, and it is envisioned that any given assay will be run in at least two different concentrations, and the concentration dosing may comprise, for example, 4, 5, 6, 7, 8, 9, 10, 11, 12, 13, 14, 15 or more concentrations of the compound being tested. Such concentrations may yield, for example, a media concentration of 0.05 micromolar, 0.1 micromolar, 0.5 micromolar, 1.0 micromolar, 2.0 micromolar, 3.0 micromolar, 4.0 micromolar, 5.0 micromolar, 10.0 micromolar, 15.0 micromolar, 20.0 micromolar, 25.0 micromolar, 30.0 micromolar, 35.0 micromolar, 40.0 micromolar, 45.0 micromolar, 50.0 micromolar, 55.0 micromolar, 60.0 micromolar, 65.0 micromolar, 70.0 micromolar, 75.0 micromolar, 80.0 micromolar, 85.0 micromolar, 90.0 micromolar, 95.0 micromolar, 80.0 micromolar, 110.0 micromolar, 120.0 micromolar, 130.0 micromolar, 140.0 micromolar, 150.0 micromolar, 160.0 micromolar, 170.0 micromolar, 180.0 micromolar, 190.0 micromolar, 200.0 micromolar, 210.0 micromolar, 220.0 micromolar, 230.0 micromolar, 240.0 micromolar, 250.0 micromolar, 260.0 micromolar, 270.0 micromolar, 280.0 micromolar, 290.0 micromolar, and 300 micromolar in culture media. It will be apparent that a cost-benefit balancing exists in which the testing of more concentrations over the desired range provides additional information, but at additional cost, due to the increased number of cell cultures, assay reagents, and time required. In one embodiment, ten different concentrations over the range of 0 micromolar to 300 micromolar are screened.

Typically, the various assays described in the present specification may employ cells seeded in 96 well plates or 384 cell plates. The cells are then exposed to the test compounds over a concentration range, for example, 0-300 micromolar. The cells are incubated in these concentrations for a given period of, for example, 6 and/or 24 hours. Subsequent to the incubation, the assays of the cluster are performed for each test compound. In one embodiment, all the assays are performed at the same time such that a complete set of data are generated under similar conditions of culture, time and handling. However, it may be that the assays are performed in batches within a few days of each other.

In specific embodiments, in addition to the cell-specific indicators of toxicity, indicators of cell health and viability may be utilized; these indicators may include, but are not limited to, indicators of cellular replication, mitochondrial function, energy balance, membrane integrity and cell mortality. In other embodiments, the indicators of cell health and viability further include indicators of oxidative stress, metabolic activation, metabolic stability, enzyme induction, enzyme inhibition, and interaction with cell membrane transporters.

The compounds to be tested may include fragments or parts of naturally-occurring compounds or may be derived from previously known compounds through a rational drug design scheme. It is proposed that compounds isolated from natural sources, such as animals, bacteria, fungi, plant sources, including leaves and bark, and marine samples may be assayed as candidates for the presence of potentially useful pharmaceutical compounds. Alternatively, pharmaceutical compounds to be screened for toxicity could also be synthesized (i.e., man-made compounds).

The types of compounds being monitored may be antiviral compounds, antibiotics, anti-inflammatory compounds, antidepressants, analgesics, antihistamines, diuretic, antihypertensive compounds, antiarrythmia drugs, chemotherapeutic compounds for the treatment of cancer, antimicrobial compounds, among others.

Regardless of the source or type of the compound to be tested for cytotoxicity, it may be necessary to monitor the biological activity of the compounds to provide an indication of the therapeutic efficacy of a particular compound or group of compounds. Of course, such assays will depend on the particular therapeutic indication being tested. Exemplary indications include efficacy against Alzheimer's disease, cancer, diabetes, depression, immunodeficiency, autoimmune disease, gastrointestinal disorder, cardiovascular disease, inflammatory disease and the like.

Cluster Analyses Assays: The use of multiple assays to develop a toxicity profile for new drugs proves to be a very powerful tool for accurately assessing the effects of a compound in a living system.

Selective assays used in the clusters of the presently disclosed and claimed inventive concept(s) provide key information pertaining to the toxicity profile of a given compound. The assays may be performed such that information regarding the various parameters is obtained at the same time during the drug development phase of drug discovery as opposed to performing the assays at different times during the drug development scheme.

In one embodiment, the assays are performed in a batch all at the same time. In other aspects, it may be useful to perform the assays on cell cultures all generated at the same time from an initial cell line.

Modules may be designed in which a cluster of assays address a specific concern. Thus, in order to monitor the effect of a specific compound on the general health of a cell, monitoring membrane integrity, mitogenesis, mitochondrial function and energy balance will be particularly useful. The specific assay employed for any of these endpoints is not considered to be limiting. Thus, any assay that provides an indication of membrane integrity may be combined with any assay that is predictive of mitogenesis (cell replication) along with any assay that is an indicator of mitochondrial function and energy balance.

In addition to a module for determining the general cell health, other modules of interest would include those that are directed to determining for example, oxidative stress, cell cycle parameters, acute inflammatory response, apoptosis, endocrine responses and interaction with cell membrane transporters such as Pgp.

In a module that determines oxidative stress, production of reactive oxygen species (ROS), reactive nitrogen species (RNS), or lipid peroxidation may be monitored. Exemplary assays to be employed in the cluster may involve monitoring endpoints that include but are not limited to glutathione/glutathione disulfide (GSH/GSSG), dichlorofluoroscindiacetate (DCFDA), lipid peroxidation, 8-isoprostane, 8-oxy guanine (8-oxy G) DNA adducts, thiobarbituric acid (TBARS), and malondialdehyde (MDA).

Modules designed to monitor cell cycle may include determining the effect on the presence or level of any given cell cycle indicator including but not limited to p53, p21, TGFβ, CDK1, PCNA, telomerase, nitric oxide, and inducible nitric oxide synthase (iNOS). Again any particular assay may be employed to determine the level or amount of any given cell cycle indicator.

Modules to monitor apoptosis may include any assays described herein or otherwise known in the art. One example of such an assay is a caspase-3 assay; however, the presently disclosed and claimed inventive concept(s) is to be understood to not be limited to the use of such assay, and any apoptosis assay may be substituted therefor in accordance with the presently disclosed and claimed inventive concept(s).

In a module designed to determine interactions with cell membrane transporter, an exemplary assay to be employed in the cluster may involve measuring a chemical compound's interaction with P-glycoprotein (Pgp). Pgp is a well characterized human ABC-transporter of the MDR/TAP subfamily. It is extensively distributed and expressed in normal cells such as those lining the intestine, liver cells, renal proximal tubular cells, and capillary endothelial cells comprising the blood brain barrier. Pgp is an ATP-dependent efflux pump with broad substrate specificity that likely evolved as a defense mechanism against harmful substances. Pgp transports various substrates across the cell membrane, thus allowing for the regulation of the distribution and bioavailability of drugs.

As stated above, the specific assay to monitor any of the given parameters is not considered crucial so long as that assay is considered by those of skill in the art to provide an appropriate indication of the particular biochemical or molecular biological endpoint to be determined, such as information about mitochondrial function, energy balance, membrane integrity, cell replication, and the like. Exemplary assays that may be used in the context of the presently disclosed and claimed inventive concept(s) can be found in the inventor's U.S. Pat. Nos. 6,998,249 and 7,615,361, previously incorporated herein by reference. However, the disclosures of said patents are not intended to be an exhaustive treatise on the description of these assays, but rather to be a guidance as to the type of assays that are available to those of skill in the art. A person having ordinary skill in the art will easily recognize assays that are known in the art that may be utilized in accordance with the presently disclosed and claimed inventive concept(s).

Predicting In vivo Toxicity of a Compound from In vitro Analyses: Once all data for a given cluster of assays are received, the data are analyzed to obtain a detailed profile of the compound's toxicity. For example, most conveniently, the data are collated over a dose response range on a single graph. In such an embodiment, the measurement evaluated for each parameter (i.e., each indicator of cell health) at any given concentration is plotted as a percentage of a control measurement obtained in the absence of the compound. However, it should be noted that the data need not be plotted on a single graph, so long as all the parameters are analyzed collectively to yield detailed information of the effects of the concentration of the compound on the different parameters to yield an overall toxicity profile. As set forth below, this overall toxicity profile will facilitate a determination of a plasma concentration Cₜₒₓ that is predicted to be toxic in vivo. Cₜₒₓ represents an estimate of the sustained plasma concentration in vivo that would result in toxicity, such as hepatotoxicity or hematopoietic toxicity.

A fundamental premise in the field of toxicology is that all compounds are poisons, and that it is the dose of the compound that determines a beneficial/therapeutic effect versus a toxic effect. Dose is affected by time of exposure, dosing regimens, pharmacokinetic parameters such as absorption, metabolism and elimination, by difference between species being treated, and by route of administration. All these factors influence the plasma concentration of a drug and its duration of exposure. Thus, in principle, in vitro screens need only account for metabolism and time of exposure. In theory, an increased exposure time should shift the dose response curve to the left (e.g., TC₅₀ is lower or the compound appears more toxic over longer exposure times). These factors all have been considered in the selection of Cₜₒₓ in the CATS assay.

For example, in vitro time course experiments utilizing H4IIE cells were conducted to evaluate the change in the dose-response curves for chloramphenical and ketoconazole over a 72 hour exposure period. The data indicated that the largest shift in IC₅₀ values occurred between 24 and 48 hours and that extended exposures (72 hours) had little or no effect on the toxicity profile. From these data it was determined that the NOEL of the 24-hour exposure correlated well with in vivo toxicity and provided acceptable estimates of the plasma concentration in vivo that would result in toxicity. When compared to in vivo animal studies, the 24-hour TC₅₀ concentration for the most sensitive toxicity exceeded the concentration at which toxicity occurred. However, the NOEL of the 24 hour period also correlated with the 72-hour TC₅₀ concentration for the more sensitive assays, and thus the 72-hour TC₅₀ concentration also provided acceptable estimates of the plasma concentration in vivo that would result in toxicity.

Studies such as these indicate that a preferred concentration for setting Cₜₒₓ is the highest concentration at which there is no observed effect on any of the indicators being measured in the cluster analysis, especially a 24-hour cluster analysis. The TC₅₀ concentration in the most sensitive of toxicity assays in a 72 hour cluster analysis has been observed to correlate with the 24 hour NOEL/Cₜₒₓ, and thus represents another datapoint in the CATS analysis that works as an estimate of the sustained plasma concentration in vivo that would result in toxicity. It will be apparent that 24 hour assays are more time-effective, and consequently, the 24 hour NOEL/Cₜₒₓ represents a preferred data point to select as Cₜₒₓ in a CATS assay. It will also be apparent that, with further time studies, it may be possible to select an equally suitable Cₜₒₓ at other CATS assay time points (e.g., between 24 and 72 hours, or less than 24 hours).

In certain embodiments, the predicting comprises performing concentration response analyses of measurements from at least three separate assays that are employed in the cluster analysis. For example, in the cell health cluster, such predicting will involve monitoring the concentration response effect of the compound on a first health indicator which monitors cellular replication, a second cell health indicator which monitors mitochondrial function, and a third cell health indicator which monitors membrane integrity. Of course, it is understood that fourth, fifth, sixth or more cell health indicators also may be employed. From these concentration response analyses, the highest concentration of the chemical compound at which a measurable toxic effect of the chemical compound is not observable, i.e., NOEL, is determined and the Cₜₒₓ is identified as the concentration that correlates to the NOEL. In choosing the concentrations of the compound for analysis, one of skill in the art should devise a dose response regimen which is selected to provide an indication of cell health at concentrations of at least two concentration values higher than the Cₜₒₓ concentration.

In the specific embodiments, the results of the analyses are depicted on a single graph on which the values are presented relative to control. The term “relative to control” means that the measurements in the presence of a given concentration of the compound are compared to a similar assay performed in the absence of the compound. The measurement in the absence of the compound is presented as the 100% measurement. The effect of the compound is thus determined as a raw figure which is then adjusted relative to that measurement that is determined in the absence of the compound.

In certain instances, there may be enough biological activity information generated for a compound or series of compounds from efficacy/activity experiments to predict a plasma concentration in humans that will be required to see a therapeutic effect. Even where such a prediction is premature, there may at least be some activity data indicating concentration of a compound or series of compounds needed to achieve a biological effect that correlates with a desired therapeutic activity. In such instances, it becomes possible to use the in vitro data from CATS analysis to estimate a therapeutic index (TI). TI for a drug is calculated by dividing the toxic concentration (conventionally a TC₅₀ value) by the beneficial therapeutic concentration. Thus, the larger the TI number, the safer the drug. For example, for a compound which has a IC₅₀ value greater than 100 micromolar, an estimated Cₜₒₓ value of 50 micromolar and an estimated therapeutic concentration of 0.2 micromolar, a TI of 500 is obtained. If the estimated Cₜₒₓ is used as the toxic concentration, then a TI of 250 is obtained. This would represent a safe drug at least in terms of liver toxicity. A TI that is at least 10 is preferred, and a TI of 100 is particularly preferred. Of course, values higher than 100 will be indicative of the drug being especially safe and would be most preferred.

Thus, in one embodiment of the invention useful for prioritizing candidate therapeutic agents, one performs an in vitro activity assay to determine concentrations of chemical compounds required to achieve an activity (Cₜₕₑᵣ), wherein the activity correlates with her, a desired therapeutic effect in vivo; predicts cytotoxicity of the compounds according to CATS assay procedures described herein; determines the ratio of Cₜₒₓ:Cₜₕₑᵣ for each compound to provide an Estimated Therapeutic Index (ETI) for each compound; and prioritizes the compounds as candidate therapeutic agents from the ETIs, wherein a higher ETI correlates with a higher priority for further development. The use of an estimated TC₅₀ from the CATS assays also would be suitable for generating ETIs and prioritizing compounds, especially where one is working with a family of structurally related compounds, and the TC₅₀ is from the same particular assay in the CATS battery of assays. (A primary piece of data often used to compare relative toxicity of compounds is the concentration of drug that produces a half maximal effect in any given assay. This value is referred to as the toxic concentration that produces a 50% response or TC₅₀).

V. Kits

In certain aspects of the presently disclosed and claimed inventive concept(s), all the necessary components for conducting one or more of the assays described herein above in Sections (I)-(IV) may be packaged into a kit. Specifically, the presently disclosed and claimed inventive concept(s) provides (1) a kit for use in an assay for renal specific toxicity; (2) a kit for use in an assay for liver specific toxicity; and (3) a kit for use in an assay for multiple organ toxicity. The kits comprise packaged sets of reagents for conducting one or more organ specific cell health assay(s), as described in detail herein above. Said kits may further comprise packaged sets of reagents for conducting at least one cell health assay selected from the group consisting of a cycle evaluation assay, mitochondrial function assay, energy balance assay, cell death assay, oxidative stress assay, metabolic activation assay, and metabolic stability assay. In addition to the reagents, the kit may also include instructions packaged with the reagents for performing one or more variations of the assay(s) of the presently disclosed and claimed inventive concept(s) using the reagents. The instructions may be fixed in any tangible medium, such as printed paper, or a computer-readable magnetic or optical medium, or instructions to reference a remote computer data source such as a worldwide web page accessible via the internet.

While the above embodiments contemplate kits in which there is at least one organ specific cell health assay, it is contemplated that the kits and the methods may involve conducting more than one organ specific cell health assay. As such, it is contemplated that the kits also may comprise the reagents for conducting a second assay from each of the classes.

### EXAMPLES

Examples are provided hereinbelow. However, the presently disclosed and claimed inventive concept(s) is to be understood to not be limited in its application to the specific experimentation, results and laboratory procedures. Rather, the Examples are simply provided as one of various embodiments and is meant to be exemplary, not exhaustive.

### Example 1

### Determining Renal Specific Toxicity (RST-Model)

Drugs that enter the body by oral administration are absorbed in the gastrointestinal tract into portal circulation and transported to the liver. Metabolism can occur in the GI wall and in the liver prior to entering general circulation. Metabolism often leads to the formation of metabolites with greater water solubility, which increases elimination via the kidney. Because the kidney is a primary route for drug elimination, it is also a primary organ for toxicity. Renal toxicity is a major concern for pharmaceutical manufacturers, and drug induced adverse effects in the kidney are major reasons for late stage attrition of promising new candidates. The ability to identify renal specific risk for toxicity early in the drug discovery process would greatly improve the probability of success in animal and human safety studies.

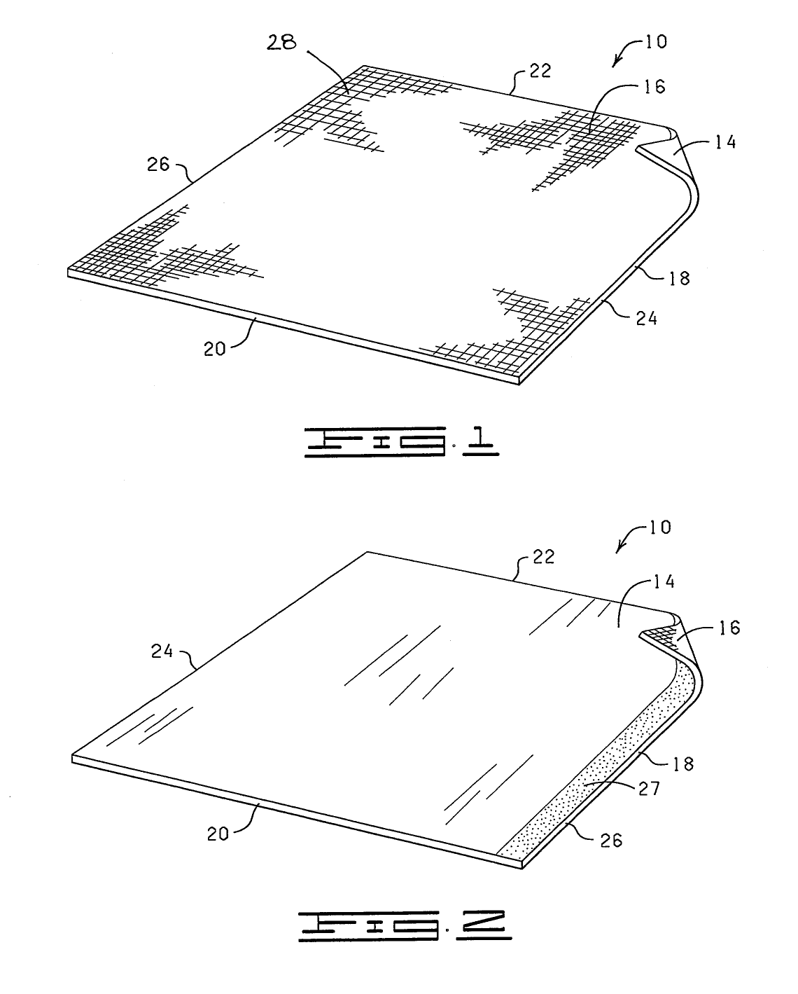

Toxicity can occur at several locations in the nephron, including but not limited to, the glomerulus, proximal tubule, distal tubule, and collecting duct (FIG. 1). The majority of drug-induced renal toxicity occurs in the proximal tubule. Cells in this region possess numerous transporters which can recognize many drugs as substrates. Uptake from plasma (basolateral side) can result in intracellular concentrations that may reach levels that cause adverse effects (FIG. 2). Immortalized cell lines can have different sensitivities to known toxicants.

In vitro models that can provide reliable information on expected adverse effects in specific organs require a unique model. The model must consist of organ specific cells that maintain in vivo physiological functions. The biochemical or molecular endpoints measured must be unique to the organ of interest, and the origin of the test cells should be species-specific.

Identifying a renal cell model in which the cells are derived from human tissue and grown in a manner that allows for transporter function may provide the most accurate in vitro means of evaluating human renal toxicity. The ideal in vitro cell model for renal toxicity should possess functional transporters and be amenable to culture on a permeable membrane that would allow polarization and establishment of a basolateral (plasma) and apical (lumen) sidedness. The resulting cell model would then possess many of the key properties associated with the in vivo situation. This Example describes the development of an in vitro model for evaluating new chemical entities in the pharmaceutical industry for their potential to cause kidney injury.

The kidney is divided into two major regions known as the medulla and cortex. Each of these regions is formed of nephrons, which are the functional units of the kidney. The nephron is divided into four major segments. These segments include the glomerulus, proximal tubule, distal tubule, and collecting duct. Although toxicity can occur in any portion of the nephron, the most common region is the proximal tubule. The proximal tubule has a basal side that faces the blood and an apical side facing the lumen of the tubule. FIG. 2 demonstrates that the renal proximal tubule cell contains many transporters which can recognize drugs as substrates. Transporter mediated uptake into cells can increase intracellular concentrations leading to toxicity. Inhibition of certain transporters can reduce elimination in urine and lead to toxicity.

As stated above, the cells of the proximal tubule possess several different types of transporter proteins, including but not limited to, the Na⁺, K⁺-ATPase pumps that maintain the polarity of the cell (negative interior relative to exterior), organic anion transporters (OAT), Sodium/phosphate transporter type I (NPT1), and multi drug resistance associated proteins (MRP), multidrug resistance protein 1 (MDR1), organic cation family (OCT). FIG. 2 illustrates the polarity of the proximal tubule cells and its transporters. These transporters can move drugs into and out of the renal proximal cells. Drugs or chemicals may also inhibit transport processes of endogenous substrates, or disrupt the elimination of other drugs co-administered, which could also result in adverse events.

In one embodiment, the presently disclosed and claimed inventive concept(s) use human proximal tubule epithelial cells (hRPTCs) as the primary model for assessing a compound's potential to cause renal toxicity. Developing a species specific cell based model is important because the renal proximal tubule cells possess many different transporter proteins that play key roles in the elimination and toxicity of drugs. Different species can have different transporter expression and function properties. Some drugs are more efficiently transported in human cells than in rat cells (Ho et al., 2000). Human cells in primary culture provide a species-specific model for assessing human risk of renal injury. The cells are grown in transwell plates (FIG. 3) to establish polarity and to set up a transport environment similar to that found in vivo. The transwell culture plates provide a platform that allows cells to form tight junctions, polarize, and develop a two compartment system. Test compounds may be added to the system in a manner that mimics apical and/or basolateral exposure scenarios. Renal specificity is achieved by determining whether the test compound is a substrate for uptake transporters or whether the test compound can bind to and alter the normal function of key renal transporters. This information is combined with data that assesses normal cellular biochemical functions. Toxicity data can then be compared to a database of drugs that have known renal liabilities and to estimated maximum therapeutic plasma concentrations to develop the final risk profile.

When information on other species is required, other embodiments of the presently disclosed and claimed inventive concept(s) utilize established cell lines in place of or in addition to the human cell model. Examples include, but are not limited to, the rabbit proximal tubule cell line LLCPK and/or the dog cell line MDCK. Both have been shown to establish polarity when cultured in a transwell model, and both possess many of the transporter systems discussed above.

Certain drugs are known to cause renal-specific-toxicity (RST). Cephalosporin antibiotics are known to cause acute renal failure in humans. The mechanism underlying this toxicity has been linked to uptake of cephalosporin by OAT transporters in the basolateral membrane of the proximal tubule. This results in a drug accumulation and subsequent cytotoxicity. Ochratoxin A is a mycotoxin that is found in grains and is known to cause renal toxicity (Naohiko and Endou, 2007). This compound is also a substrate for OAT transporters, and its toxicity is related to its hyper accumulation in renal proximal cells. The antiviral drugs adefovir and cidofovir produce renal specific toxicity as a result of OAT1 transporter uptake into renal cells (Ho et al. 2000). Drugs that increase the expression of uptake transporters on the basolateral membrane can increase intracellular concentrations leading to increased toxicity.

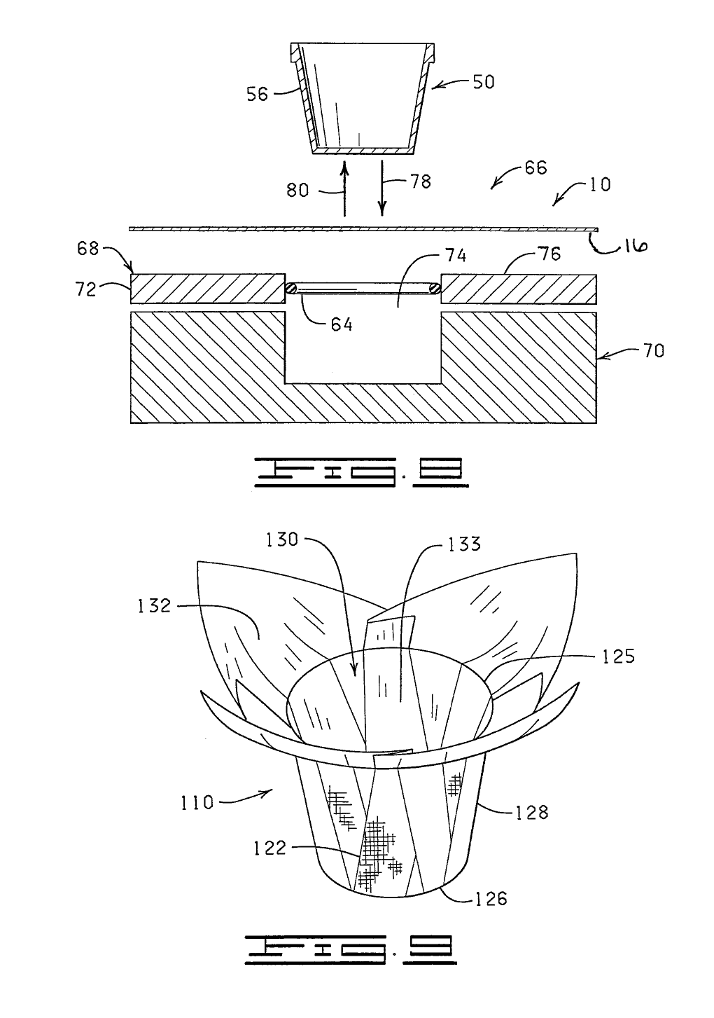

In certain embodiments of the presently disclosed and claimed inventive concept(s), the Renal-Specific-Toxicity (RST) Model Acute-RST Test (designed for higher throughput and lower cost; see FIG. 5 for a proposed plate organization) is conducted as follows: hRPTCs or other cell model are established in transwell culture and exposed to at least one test compound at concentrations of 0, 1, 10, 100 μM. Said exposure is to the basolateral surface only, and is exposed for 72 hours. Each exposure is performed in replicates of 3 wells. Cell viability is then measured; the assay may be an assay such as NGAL, KIM1, ATP, or any other assay described herein; in addition, only one assay is necessary for this test. The data obtained is then compared to human liver HepG2 cell cytotoxicity at the same exposures, time, and replicates (GST or LDH leakage only). If possible, the ratio of IC_{50 renal} versus TC_{50 hepatic} is calculated to determine organ specificity. Curve fitting and extrapolation programs are then used to estimate TC₅₀ values when needed.

In other embodiments of the presently disclosed and claimed inventive concept(s), the Mechanism-Risk-Based RST Test (which is designed to provide a mechanistic picture of drug renal toxicity) is conducted as follows: human proximal tubule cells are established in transwell culture. An assessment of cytotoxicity is performed by exposing the cells to the test compound at six exposure concentrations for 24 and 72 hours, and wherein the exposures include both basolateral exposure as well as apical exposure. Cell viability is then measured via mitochondrial function, lysosomal toxicity, membrane integrity, expression of transporters (such as but not limited to, OAT 1,3,4,5; OCT 1,2; MRP2,4; MDR1; and OATP4C1) and/or PKC activity. TC₂₀, TC₅₀, and TC₉₀ values are then determined from the response curves prepared based on the measurements above. The assessment of cytotoxicity is then repeated in the presence of transporter-specific inhibitors or substrates. Cell viability is monitored, and if viability is increased in the presence of inhibitor, then toxicity is related to that transporter. The Kₘ of transporter(s) identified in the second assessment of toxicity is determined using isolated cloned transporters in membrane vesicles or the cell model described above.

Renal specificity of toxicity can then be verified by a multiple organ screen (as described in more detail in Example 3). Additional information on renal specificity is achieved by comparing human renal cell toxicity data to human primary liver cell toxicity. The ratio provides a toxicity index. Compounds specific to kidney will have lower mean TC₅₀ values than liver, hence a low ratio. Compounds with toxicity in both organs will show ratios closer to 1, while liver toxins would have ratios greater than 1.

Specifically, normal human liver cells in primary culture are exposed to the test drugs at the same concentrations and times, and the assessment of cytotoxicity calculated as described above (to provide a TC_{50 hepatic}). Using the TC_{50 renal} calculated in the paragraph above, the ratio of the IC_{50 renal} to TC_{50 hepatic} can be calculated for viability endpoints. A ratio of 1.0 indicates no specificity, ratios greater than 1.0 indicate renal specificity, and ratios less than one indicate liver specificity.

A maximum therapeutic plasma concentration can also be calculated using standard ADME and pharmacokinetic models.

The in vitro toxicity results obtained in this test can then be compared to a database of known renal toxic drugs (as well as drugs with varying renal toxic potencies) and the risk determined using the Renal Risk Analysis Chart (FIG. 7). The maximum therapeutic concentration (Cₘₐₓ) is compared to renal specific markers and/or the concentration that produces half maximal toxicity (EC₅₀ or TC₅₀). As shown in FIG. 7, as Cₘₐₓ or plasma concentration exceeds the renal tox marker EC₅₀, the probability of toxicity increases.

Materials and Methods for Example 1

Cell Culture: Two cell types were used in this Example—primary human renal proximal tubule cells (hRPTCs) and a well characterized porcine renal proximal tubule (LLC-PK1) cell line. The hRPTCs were obtained from Lonza, Clonetics (Walkersville, Md.) and the LLC-PK1 was obtained from ATCC.

Establishing Transwell Cultures: The hRPTCs were seeded into Corning transwell-COL 24-well tissue culture plates at a density of 7.4×10⁴ cells/well. LLC-PK1 cells were seeded into BD 351181 transwell 24-well tissue culture plates at a cell density of 1.65×10⁵ cells/well (FIG. 3). On day 6 of incubation, formation of tight-junctions between cells was determined by Lucifer Yellow and Mannitol. The growth medium used with the hRPTCs was modified DMEM/Ham's F-12, and the medium used for LLC-PK1 was DMEM with 10% FBS (Elwi et al. 2009; Morshed and McMartin, 1995).

Transport Assays: To determine transporter specific activity, several known substrates were selected: TEA (OCT1 and OCT2), Digoxin (OATP4C1), Metformin (OCT2 basolateral and MATE1 apical). LLC-PK1 cells were seeded in BD 351181 24-well tissue culture plates at a cell density of 1.65×10⁵ cells/well. After culturing for 6 days, apical and basolateral chambers were washed at room temperature with D-PBS buffer (containing 137 mM NaCl, 3 mM KCl, 8 mM Na₂HPO₄, 1.5 mM KH₂PO₄, 1 mM CaCl₂, 0.5 mM MgCl₂ and 5 mM D-glucose; pH 7.4) then incubated with non-radiolabeled substrate on both apical and basolateral sides for 60 minutes. Media was removed and the cells rinsed with buffer prior to adding the radiolabeled substrate. Radiolabeled substrate (with or without inhibitor) was added to apical or basolateral chambers, and samples were collected from the opposite side at 40 minutes. Cellular uptake was determined by washing the transwell membranes containing the cells twice with ice-cold D-PBS, then transferring the insert with cells to scintillation vials containing 2% Triton X-100. Scintillation was counted using Opti-Flour (Perkin Elmer) and in a Packard Tri-Carb 2100TR liquid scintillation counter. DPM background was subtracted. Cellular uptake (lysate) values were normalized to total protein, which was determined by the Pierce BCA protein assay. Three independent flux experiments, each with triplicate measurements, were performed.

Cytotoxicity: Cell viability was determined by measuring intracellular ATP levels with ATP-Lite from Perkin Elmer according to the manufacturer's instructions. Cell proliferation was determined from bromodeoxyuridine (BrdU) incorporation. Membrane integrity was measured using glutathione S-transferase (GST) as a leakage marker (Argutus). The GST assay was done according to the manufacturer's instructions. Gamma-glutamyl transferase activity (GGT) was measured using the Catachem GGT kit with modifications.

Results of Example 1

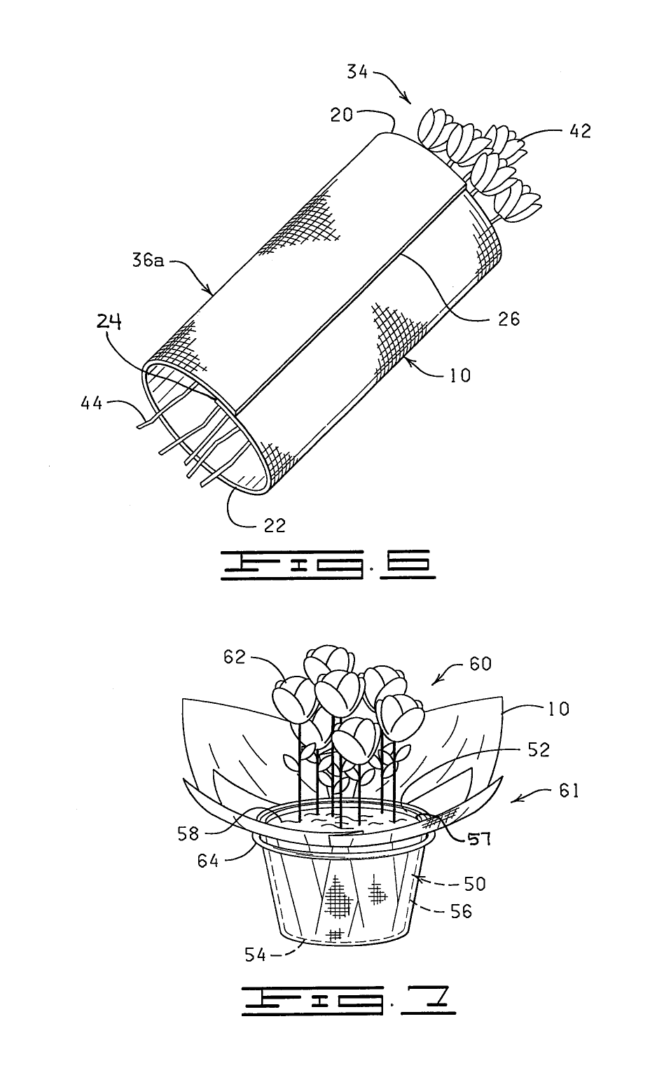

In FIG. 4, several transporters were evaluated in the hRPTC model (Table 1). Meformin is a Substrate for hOCT2 (basolateral side) and MATE1 (apical side) (Tsuda et al., 2009). FIG. 4 represents the mean±SEM of three separate experiments done in triplicate, *=p<0.05, **=p<0.01. Cimetidine at 500 μM or 1 mM inhibited both cellular uptake and basolateral to apical flux in the LLC-PK1 cell model. In hRPTCs, cellular uptake was inhibited by cimetidine; however, basolateral-to-apical flux was not inhibited by cimetidine, suggesting that paracellular leakage was greater than transport mediated flux or that the apical transporters were not functional.

Next, cisplatin cytotoxicity was evaluated in two (hRPTC and NRK 52) kidney cell types and a human hepatoma (HepG2) cell line, as shown in FIG. 6. The human derived primary proximal tubule cells (hRPTC) were the most sensitive, with an IC₅₀ for ATP depletion of approximately 80 μM. Cell number (solid circles) was not affected below 300 μM. Cell death (open squares), as determined by membrane integrity, was also not reduced at exposure concentrations less than 300 μM. GGT (red open circle) is a marker for brush border membrane toxicity, and the release of GGT into the medium coincided with loss of ATP.

TABLE 1
Renal Proximal Tubule Transporters
(taken from Feng et al., 2008)

| Transporter | | Probe | |
|---|---|---|---|
| Type | Location | Substrate | Inhibitor |
| hOAT1 | Basolateral | PAH | Probenecid |
| hOAT3 | Basolateral | Estrone Sulfate | Probenecid |
| hOCT2 | Basolateral | Metformin, TEA | Cimetadine |
| | | | (1000M) |
| hOATP4C1 | Basolateral | Digoxin | Verapamil |
| MRP4 | Apical | PAH | Probenecid |
| MDR1 | Apical | Digoxin | Verapamil, |
| | | | Cyclosporine A |
| MATE1 | Apical | Metformin | Cimetadine |
| | | | (1 μM) |

Thus, the data presented in Example 1 demonstrate that the species and cell type selected can impact sensitivity of the cell to known renal toxicants. Cryopreserved human proximal tubule cells grown on a transwell culture plate may provide a more in vivo-like model for assessing kidney specific injury.

Developing in vitro models that can predict organ specific toxicity, requires careful characterization of the cell system. This includes understanding the cell biology and functional properties relative to in vivo conditions. The human derived primary proximal tubule cell offers a means of rapidly evaluating new chemical entities for kidney specific toxicity. These cells appear to possess active transporters on the basolateral membrane, but not on the apical membrane. Renal specific biomarkers will also add to this in vitro approach.

### Example 2

### Liver Specific Toxicity Screen (CeeTox LST-Screen)

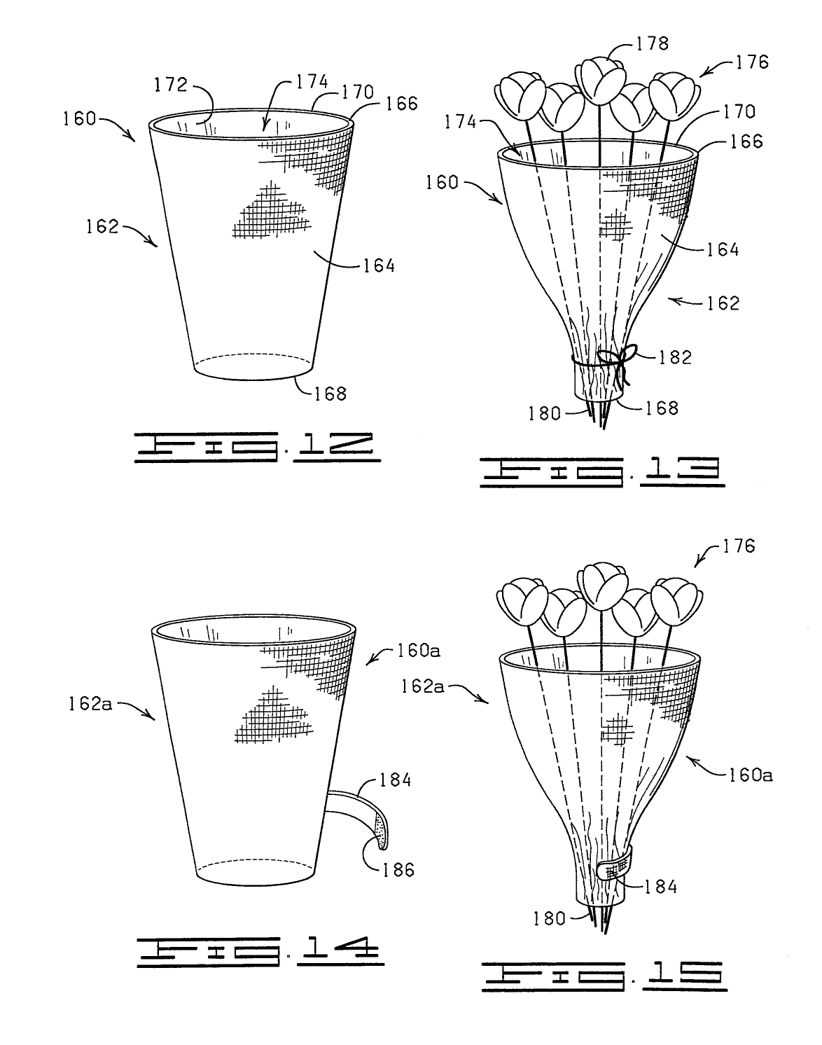

Most early drug discovery efforts incorporate in vitro assays to identify and mitigate the risk of a new chemical entity causing liver toxicity in preclinical safety studies. In vitro approaches can easily identify severe chemical off-target toxicity. However, these assays must be carefully designed in order to define more subtle toxicity that may not be detected in animal safety studies or in clinical trials, but show up once a new drug enters the market and is used in a large patient population. Many times this post market toxicity is labeled as idiosyncratic and can result in the withdrawal of promising new drugs. Therefore, in vitro models that can identify biochemical profiles consistent with organ specific idiosyncratic toxicity would be of great value. Drugs that enter the body by oral administration are absorbed in the gastrointestinal tract into portal circulation and transported to the liver. The primary cell in the liver is the hepatocyte, and a key feature of liver physiology is the formation of canalicular membranes between hepatocytes and the presence of transporters that assist in the elimination of drugs (FIG. 8). Inhibition of transporter activity or changes in transporter expression can alter intracellular concentrations of a drug and hence influence toxicity. To identify this type of subtle toxicity, an integrated multi-parameter approach has been developed (FIG. 9). The method utilizes cell lines and primary hepatocytes in sandwich culture, combined with several liver specific and general cell health markers. The model was tested by evaluating drugs withdrawn as well as members of the same drug group that remain on the market and appear safe. Nefazodone and troglitazone were withdrawn for liver toxicity, while ketoconazole is an example of a drug that received a black box warning (Table 2). Analysis of the data obtained demonstrates that unique biochemical profiles indicative of risk for liver toxicity can be identified for the drugs associated with adverse effects, but not drugs in the same class that have not been associated with liver injury.

In this method of the presently disclosed and claimed inventive concept(s), the gold standard for liver work is used: primary hepatocytes from a mammal, such as but not limited to, rat, dog, monkey and human. The primary hepatocytes are established in sandwich culture. At least one of various indicators of hepatic cell health are then monitored; said indicators include, but are not limited to: (a) liver specific endpoints for cholestasis (including, but not limited to, BSEP, UGT1A1, GGT); (b) biochemical markers for cell health (including, but not limited to, GST leakage, ATP, MTT); and (c) lysosomal stress (lipidosis) with nile red assay.

Hepatocytes in sandwich culture develop functional canalicular membranes, develop polarity with regard to transporters, and retain most in vivo functional attributes. The presently disclosed and claimed inventive concept(s) provides an in vitro method that identifies drugs or chemicals that have a high probability of producing liver specific toxicity. The method is based on data accumulated from the model of the presently disclosed and claimed inventive concept(s), which exhibits the following properties:
(1) Cells are organ and species specific;
(2) Cells are grown in sandwich culture and have functional canalicular membranes;
(3) Multiple liver specific biochemical endpoints are collected over a detailed concentration response curve;
(4) The test focuses on canalicular/bile flow toxicity (such as, but not limited to, BSEP, UGT1A1, and GGT);
(5) General hepatocyte health: lipidosis (Nile red), mitochondrial function (ATP, MTT, JC-1), membrane integrity, apoptosis (caspase 3), oxidative stress (GSH levels);
(6) Key metabolic components which include CYP1A, 3A, 4A expression levels;
(7) Evaluation of normal metabolic functions, glycolysis, gluconeogenesis, lipogenesis, fatty acid oxidation. PEPCK1 and 2, and glucose 6-phosphate levels are used for gluconeogenesis. PPAR alpha binding also an important indicator. CAR receptor expression and activation, CYP2B induction;
(8) The methods identifies compounds that can alter glucose, and lipid metabolism—both key functions of the liver;
(9) Analysis of concentration response curves provides TC₅₀ values that can be used to identify liver toxicity and liver specific toxicity;
(10) The analysis of each assay and the corresponding concentration response curve allows a determination of the Cₜₒₓ value (disclosed and claimed in U.S. Pat. No. 6,998,249, previously incorporated herein by reference). The Cₜₒₓ value represents a value that corresponds to the plasma concentration where toxicity would be expected to occur;
(11) By evaluating multiple endpoints that encompass all major areas of liver function, it is possible to determine whether a new drug or chemical will produce liver toxicity. More importantly the method can identify the type of liver damage;
(12) Concentration response curves are analyzed to obtain the TC₂₀, TC₅₀ and TC₉₀ values.
(13) These values can be compared to the maximum therapeutic plasma concentration achieved in the clinic to determine risk to humans; and
(14) The same risk panel used for renal toxicity panel described in FIG. 7 (Example 1) can be applied here.

Materials and Methods for Example 2

Cell Culture: Primary hepatocytes in sandwich culture were obtained freshly-plated from outside vendors and used to assess general liver toxicity. Hepatocytes were plated in 24-well or 96-well microplates at a density of 400 K/well and 100 K/well, respectively, and kept at 37° C., 5% CO₂ in a humidified incubator. Sandwich culture plates have a collagen substratum with Matrigel overlay, optimal growth conditions for hepatocytes with intact and functional bile canalicular networks. After 3 days in culture, cells were shipped to the inventor. Upon receipt, medium was replaced with fresh Williams E medium (Sigma) containing 10% bovine serum (Invitrogen), and cells were acclimated overnight prior to treatment (Hewitt et al. 2007).

Rat (H4IIE) cells were seeded in flat bottom 96-well plates at a density of 10,000 cells/well in Eagles Minimum Essential Medium (Sigma Chemical) supplemented with 10% bovine serum and 10% calf serum (Invitrogen). Cells were allowed to equilibrate for approximately 48 hours to allow cells to move into a stable growth phase prior to treatment.

Cytotoxicity: ATP was measured using an ATP-Lite kit from Perkin Elmer according to the manufacturer's instructions. Membrane integrity was monitored by determining the presence of α-Glutathione S-transferase (α-GST), released into the culture medium using an ELISA assay (Argutus Medical). Intracellular glutathione levels were determined essentially as described by Griffith (1980) with modifications. Cell mass in each well was measured with propidium iodide (PI). This specific nucleic acid binding dye fluoresces when intercalated within the nucleic acids. After incubation, the test compound was removed by aspiration of the media and Triton X-100 solution containing propidium iodide was added to permeabilized cells.

8-ISO levels were determined using an ELISA. 8-ISO is a member of a family of eicosanoids produced non-enzymatically by random oxidation of tissue phospholipids by oxygen radicals. Therefore, an increase in 8-ISO is an indirect measure of increased lipid peroxidation (Vacchiano and Tempel, 1994).

γ-Glutamyltransferase (GGT) activity was measured using the Catachem GGT kit with modifications. After completion of exposures, media was removed from the plates and cell and cell supernatants were stored at −80° C. until analyzed.

Rat or human BSEP cell-free assay were performed according to GenoMembrane protocol for BSEP transport analysis.

Results of Example 2

As shown in FIG. 8, activation of nuclear transcription factors (PXR, FXR) can change the abundance of metabolizing enzymes and transporters. Inhibition of transporters (e.g., BSEP) can cause cholestatic liver toxicity or alter the hepatic clearance of drugs.

Thus, the Hepatoma (H4IIE) cell line was used to identify severe toxicity during Hit-to-Lead (FIG. 9). As new chemical entities are refined and optimized, testing for subtle species- and organ-specific toxicity should be employed. For liver, a well characterized model is primary hepatocytes in sandwich culture. Testing can be done with hepatocytes from rat, dog, monkey, or human.

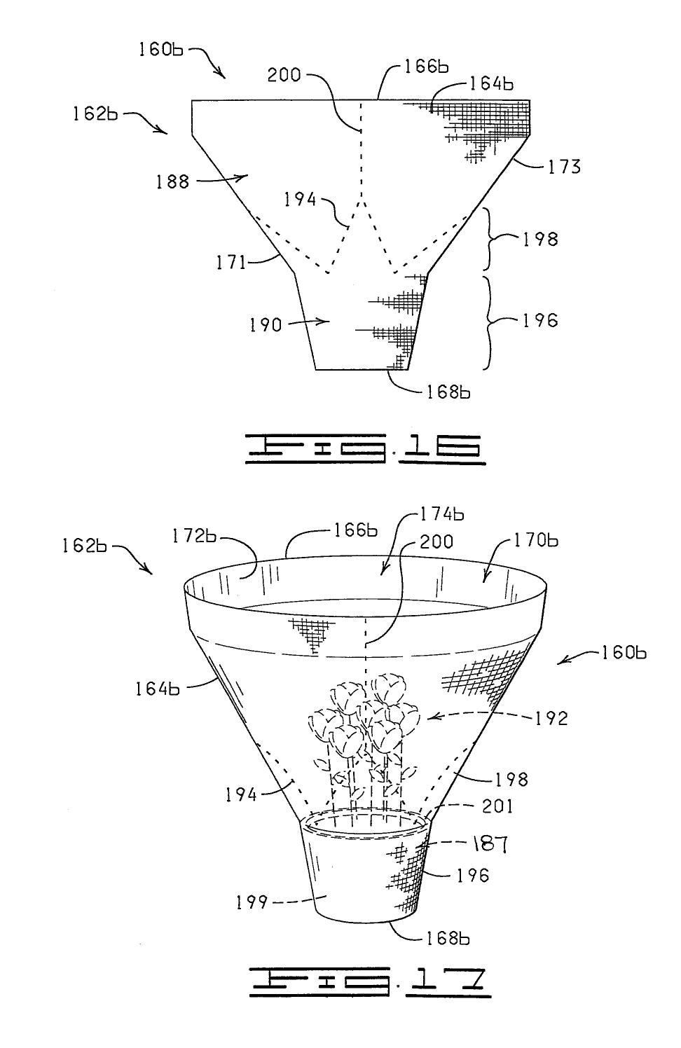

FIG. 10 illustrates that primary hepatocytes in sandwich culture allow cells to develop canalicular membranes and transporter activity. Cellular morphology is more in vivo like. Metabolism and overall viability are also improved in this model.

FIG. 11 illustrates one analysis of various assays constructed in accordance with the presently disclosed and claimed inventive concept(s). Primary hepatocytes in sandwich culture provide an excellent model for assessing toxicity that targets the canalicular membrane. GGT release into the culture medium is specific for canalicular membrane effects. α-naphthyl-isothiocyanate (ANIT) causes canalicular damage, which then initiates hepatocyte toxicity. Values represent the mean of 4 replicate wells, with a coefficient of variation of less than 15%.

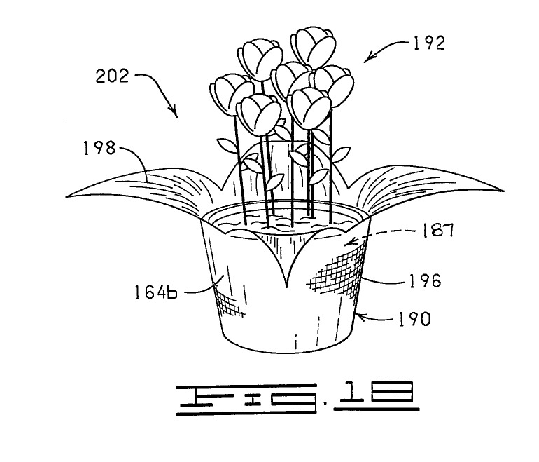

FIG. 12 illustrates a comparison of three non-tricyclic antidepressants in the assays of the presently disclosed and claimed inventive concept(s). The suspected mechanisms for nefazodone liver toxicity include metabolic activation and inhibition of BSEP. Assays for general cell health showed nefazodone as most toxic. In addition, nefazodone was the most effective at depleting intracellular glutathione levels (IC₅₀=<50 μM). These results, combined with inhibition of the bile salt export pump (BSEP, Table 1), provide a risk profile that would flag nefazodone as more toxic than the other drugs in the same class. Values represent the mean of four replicates. Coefficient of variation was less than 15%.

TABLE 2
Integrated Model for Determining Liver Toxicity

| | | | | | Inhibition | Inhibition | Reactive | DDI | Clin | |
|---|---|---|---|---|---|---|---|---|---|---|
| Drug | BSEP | UGT1A | Mitochondrial | GSH | CYP3A | CYP2C9 | Metabolite | Potential | Cholestatic | DILI |
| [symbol] | 5 | 6 | 100 | N | 0.15 | N | Y | Y | Y | Y |
| [symbol] | N | N | >300 | N | N | 7 | N | Y | N | N |
| Itraconazole | Y | ND | 150 | N | 2.3 | N | N | Y | Y | Y |
| [symbol] | 1.3/0.23 | ND | 100 | 15 | Y | Y | Y | Y | Y | Y |
| Pioglitazone | 5 | ND | >300 | N | N | N | N | N | Y-reversible | Y |
| Rosiglitazone | 8 | ND | >300 | N | N | N | N | N | ? | N |
| [symbol] | 9 | ND | 90 | <30 | N | N | Y | N | Y | Y |
| [symbol] | N | ND | 300 | N | N | N | N | N | N | N |
| [symbol] | N | ND | >300 | N | N | N | N | N | N | N |

Safer Drugs
Trazodone Pioglitazone Fluconazole
Buspirone Rosiglitazone Itraconazole
DDI = Drug-drug interaction
DILI = Drug induced liver injury [symbol]
= High risk [symbol]
= Moderate risk [symbol]
= Low risk [symbol]
indicates data missing or illegible when filed

These results demonstrate that an integrated multiple endpoint approach combined with concentration response and organ specific biomarkers (e.g., BSEP, GGT) can identify drugs that cause liver toxicity. Cell lines improve throughput and provide a good system for identifying acute toxicity and for rank-ordering compounds. Primary hepatocytes in sandwich culture provide a more in vivo like model for assessing organ specific toxicity because they flag compounds that inhibit transporters, activate nuclear transcription factors, or damage canalicular membranes. Primary hepatocytes can also be used to characterize species-specific effects. Compounds in the same drug class can be rank-ordered, and those with the highest probability of causing liver toxicity in a small patient population can be identified (Table 2).

Developing in vitro models that can predict organ specific toxicity requires careful characterization of the cell system. This includes understanding the cell biology and functional properties relative to in vivo conditions. Biomarkers or biochemical functions unique to the liver are essential for finding those drugs that may not be identified as toxic in animal safety studies. When in vitro data from cell lines, primary hepatocytes, and purified vesicles or enzymes are combined, it is possible to flag drugs that may cause liver toxicity in humans. When these assays are incorporated prior to candidate selection, the risk of idiosyncratic liver toxicity occurring in patients should be greatly reduced.

### Example 3

### In Vitro Approaches for Organ Specific Toxicity Screening

An important step in the drug discovery process is the optimization of desired drug properties. The ability to identify potential drug liabilities in the lead optimization phase would be a significant advantage to discovery scientists because it enables them to evaluate how changes in chemistry affect toxicity. In vitro methods for assessing various ADME issues have been successful. The use of cell models to evaluate cytotoxicity has also improved in recent years. However, the ability to use in vitro models to predict organ specific toxicity has hitherto not been adequately addressed. This Example demonstrates that by incorporating a two cell model, organ specific toxicity endpoints, and markers of general cell health, it is possible to identify a drug's potential to cause liver, heart, and/or kidney toxicity.

In one embodiment, hepatocytes are used as the reference cell type. Heart and renal cell toxicity are measured in organ-specific cell models and compared to liver effects. Methods of predicting cardiac toxicity are described in detail in U.S. Pat. No. 7,615,361, previously incorporated herein by reference, while methods of predicting renal cell toxicity and liver toxicity are described herein above as well as in Examples 1 and 2, respectively. Concentration response data provides TC₅₀ values for each responding endpoint in each cell model. Organ specificity is determined by calculating the ratio of heart TC₅₀ data to liver TC₅₀ data and kidney TC₅₀ data to liver TC₅₀ data. The resulting ratio is the toxicity index (TI). When the ratio approaches 1.0, there is no organ specificity. When the TI is less than 1.0, specificity is toward the organ in the numerator (heart or kidney). If the TI is greater than 1.0, the specificity is for liver. This information can be combined with organ specific gene markers for effects that may not be acutely toxic. The data indicate that this approach provides a rapid and low cost means of understanding risk for organ specific toxicity.

One embodiment of plate organizations for said screen can be found in FIG. 13; however, the presently disclosed and claimed inventive concept(s) are not specifically limited to the embodiment shown in FIG. 13. Rather, the scope of the presently disclosed and claimed inventive concept(s) include any plate organization that will allow for methods of determining levels of multiple organ toxicity for one or more chemical compound(s).

In the embodiment shown in FIG. 13, the multiple organ toxicity screen includes a renal toxicity screen as described in Example 1. In the multiple organ toxicity screen depicted in FIG. 13, the renal toxicity screen is shown in the top panel, and includes the use of at least one test compound and up to four test compounds (labeled “Test Cpd 1”, “Test Cpd 2”, “Test Cpd 3” and “Test Cpd 4”). The compound(s) is tested at three different concentrations (0, 1, 10 and 100 μM) and in replicates of three wells at a single time point. Four assays are conducted, including N-acetyl-β-D-glucuronidase leakage, ATP, and Nile red. Based on these measurements, a TC_{50 renal} value is determined as described in detail herein.

The multiple organ toxicity screen of FIG. 13 also includes a liver toxicity screen as described in Example 2, and shown in FIG. 13 in the middle panel. The liver toxicity screen includes the use of at least one test compound and up to four test compounds (labeled “Test Cpd 1”, “Test Cpd 2”, “Test Cpd 3” and “Test Cpd 4” in the top panel; note that the middle and bottom panels contain the same plate divisions and thus allow the measurements of up to four test compounds at a time as well). The compound(s) is tested at three different concentrations (0, 1, 10 and 100 μM) and in replicates of three wells at a single time point. Five assays are conducted, including GST-α leakage, GGT, BSEP, ATP, and Nile red. Based on these measurements, a TC_{50 hepatic} value is determined as described in detail herein.

The multiple organ toxicity screen of FIG. 13 also includes a cardiac toxicity screen as described in U.S. Pat. No. 7,615,361 (previously incorporated herein by reference), and shown in FIG. 13 in the bottom panel. The cardiac toxicity screen includes the use of at least one test compound and up to four test compounds (labeled “Test Cpd 1”, “Test Cpd 2”, “Test Cpd 3” and “Test Cpd 4” in the top panel; note that the middle and bottom panels contain the same plate divisions and thus allow the measurements of up to four test compounds at a time as well). The compound(s) is tested at three different concentrations (0, 1, 10 and 100 μM) and in replicates of three wells at a single time point. Three or four assays are conducted, including Troponin 1, ATP, Nile red, and GSH. Based on these measurements, a TC_{50 CM} value is determined as described in the '361 patent.

Organ specificity is then determined by calculating the ratio of TC_{50 CM} to TC_{50 hepatic} and the ratio of TC_{50 renal} to TC_{50 hepatic}. The resulting ratio is the toxicity index (TI). When the ratio approaches 1.0, there is no organ specificity (i.e., equal toxicity in the two compared organs). When the TI is less than 1.0, specificity is toward the organ in the numerator (heart or kidney). If the TI is greater than 1.0, the specificity is for liver.

Thus, in accordance with the presently disclosed and claimed inventive concept(s), there have been provided methods of determining a level of toxicity for a chemical compound, as well as methods of determining organ-specific and multiple organ toxicities, that fully satisfy the objectives and advantages set forth hereinabove. Although the invention has been described in conjunction with the specific drawings, experimentation, results and language set forth hereinabove, it is evident that many alternatives, modifications, and variations will be apparent to those skilled in the art. Accordingly, it is intended to embrace all such alternatives, modifications and variations that fall within the spirit and broad scope of the invention.

### REFERENCES

The following references, to the extent that they provide exemplary procedural or other details supplementary to those set forth herein, are specifically incorporated herein by reference.
Elwi, A. N. et al. (2009) Am J Physiol Renal Physiol 296, F1439-51
Feng, B. et al. (2008) Clin Pharmacol Therap, 83, 567-576
Griffith, O. W. (1980). Anal Biochem 106(1): 207-12.
He, K., R. E. Talaat, et al. (2004). Drug Metab Dispos 32(6): 639-46.
Hewitt, N. J., M. J. Lechon, et al. (2007). Drug Metab Rev 39(1): 159-234.
Morshed, K. M. and K. E. McMartin (1995) In vitro Cell Dev Biol Anim 31, 107-14
Tsuda, M. et al. (2009) J Pharmacol Exper Therap, 329, 185-191
Usui, T., M. Mise, et al. (2009). Drug Metab Dispos 37(12): 2383-92.
Vacchiano, C. A. and G. E. Tempel (1994). J Appl Physiol 77(6): 2912-7.
Wilkening, S., F. Stahl, et al. (2003). Drug Metab Dispos 31(8): 1035-42.

What is claimed is:

1. A method of assessing risk for renal specific toxicity of a chemical compound, comprising the steps of:
(a) determining a concentration of the chemical compound that produces a half maximal toxic effect (TC_{50 specific renal}) for at least one indicator of renal specific cell health in freshly isolated mammalian proximal tubule cells;
(b) determining a concentration of the chemical compound that produces a half maximal toxic effect (TC_{50 general renal}) for at least one general indicator of cell health in freshly isolated mammalian proximal tubule cells;
(c) determining a concentration of the chemical compound that produces a half maximal toxic effect (TC_{50 hepatic}) in freshly isolated liver cells for the same at least one general indicator of cell health measured in (b);
(d) calculating a mean TC_{50 renal} from the TC_{50 specific renal} and TC_{50 general renal} values; and
(e) calculating a toxicity index (TI) as the ratio of the mean TC_{50 renal} over the TC_{50 hepatic}, wherein when the TI is equal to 1.0, there is no organ specificity, when the TI is <1.0, the indication is renal toxicity, and when the TI is >1.0, the indication is liver toxicity.

2. The method of claim 1, further comprising the step of comparing the TI to a database of chemical compounds that have known levels of renal toxicity.

3. The method of claim 1, further comprising the step of comparing at least one of IC_{50 specific renal}, TC_{50 general renal}, and mean TC_{50 renal} to a No Observed Effect Level (NOAEL) and a maximum therapeutic concentration (TCₘₐₓ) for the chemical compound.

4. The method of claim 3, wherein a probability of toxicity increases as mean TC_{50 renal} approaches Cₘₐₓ.

5. The method of claim 1, wherein the TC_{50 specific renal} is determined by a method comprising the steps of:
providing freshly isolated mammalian proximal tubule cells and culturing said cells under conditions that allow said cells to establish polarity and basolateral and apical sidedness;
culturing the freshly isolated mammalian proximal tubule cells in the presence of a plurality of concentrations of said chemical compound;
measuring at least one indicator of renal specific cell health at the plurality of concentrations of said chemical compound for the proximal tubule cells;
performing a concentration response analysis for the at least one indicator of renal specific cell health from the measurements obtained at the plurality of concentrations of the chemical compound;
identifying from the concentration response analysis the highest concentration of said chemical compound at which no measurable toxic effect was observed for the at least one indicator of renal specific cell health; and
determining a concentration that produces a half maximal toxic effect (TC_{50 specific renal}) for the at least one indicator of renal specific cell health.

6. The method of claim 5, wherein in the step of culturing the cells in the presence of said chemical compound, the chemical compound is exposed to an apical side of said cells.

7. The method of claim 5, wherein in the step of culturing the cells in the presence of said chemical compound, the chemical compound is exposed to a basolateral side of said cells.

8. The method of claim 1, wherein the mammalian proximal tubule cells are specific to the species in which the toxicity determination is required.

9. The method of claim 8, wherein the mammalian proximal tubule cells are selected from the group consisting of human proximal tubule epithelial cells (hRPTCs), the rabbit proximal tubule cell line LLCPK1, and the dog cell line MDCK.

10. The method of claim 1, wherein the at least one indicator of renal specific cell health is selected from the group consisting of Neutrophil gelatinase associated lipocalin (also referred to as NGAL, LPN2 and Lpn2), Kidney injury marker-1 (KIM1), clusterin, and combinations thereof.

11. The method of claim 10, wherein the at least one indicator of renal specific cell health is at least one of NGAL protein and NGAL mRNA expression, whereby a reduction in secretion of NGAL protein and/or an increase in mRNA expression of NGAL demonstrates renal toxicity.

12. The method of claim 10, wherein the at least one indicator of renal specific cell health is at least one of secreted clusterin protein and clusterin mRNA expression, and whereby a decrease in secretion of clusterin protein and/or an increase in clusterin mRNA expression demonstrates renal toxicity.

13. The method of claim 10, wherein the at least one indicator of renal specific cell health is at least one of secreted KIM1 protein and KIM1 mRNA expression, and whereby an increase in secretion of KIM1 protein and/or an increase in KIM1 mRNA expression demonstrates renal toxicity.

14. The method of claim 1, wherein the TC_{50 general renal} and TC_{50 general hepatic} are determined by a method comprising the steps of:
providing freshly isolated mammalian proximal tubule cells and culturing said cells under conditions that allow said cells to establish polarity and basolateral and apical sidedness;
providing freshly isolated liver cells;
culturing the freshly isolated mammalian proximal tubule cells in the presence of four or more concentrations of said chemical compound;
culturing the freshly isolated liver cells in the presence of four or more concentrations of said chemical compound;
measuring at least one general indicator of cell health at the four or more concentrations of said chemical compound for the renal proximal tubule cells;
measuring the same general indicator(s) of cell health at the four or more concentrations of said chemical compound for the liver cells;
determining a level of toxicity of the chemical compound from these measurements by the following steps:
(a) performing a concentration response analysis for each indicator of cell health from the measurements taken for the proximal tubule cells;
(b) performing a concentration response analysis for each indicator of cell health from the measurements taken for the liver cells;
(c) identifying, from the concentration response analysis of (a), the highest concentration of said chemical compound at which no measurable toxic effect was observed for each measured indicator of cell health for the proximal tubule cells;
(d) identifying, from the concentration response analysis of (b), the highest concentration of said chemical compound at which no measurable toxic effect was observed for each measured indicator of cell health for the liver cells;
(e) determining a concentration that produces a half maximal toxic effect (TC_{50 general renal}) for the measured indicator(s) of cell health for the proximal tubule cells; and
(f) determining a concentration that produces a half maximal toxic effect (TC_{50 general hepatic}) for the measured indicator(s) of cell health for the liver cells.

15. The method of claim 14, wherein the general indicators of cell health are selected from the group consisting of indicators of cell membrane integrity, oxidative stress, cell mortality, mitochondrial function, cell proliferation, lysosomal toxicity, and combinations thereof.

16. The method of claim 15, wherein the general indicators of cell health are selected from the group consisting of GGT, AP, ALT, AST, LDH, GST, DCFDA, caspase 3, caspase 8, caspase 9, a BAX/Bcl1 ratio, MTT, ATP, BrdU, and combinations thereof.

17. A method of assessing risk for hepatic toxicity of a chemical compound, comprising the steps of:
determining a concentration of the chemical compound that produces a half maximal toxic effect (TC_{50 specific hepatic}) for at least one indicator of hepatic specific cell health in freshly isolated mammalian primary hepatocytes and/or a specific hepatoma cell line;
determining a concentration of the chemical compound that produces a half maximal toxic effect (TC_{50 general hepatic}) for at least one general indicator of cell health in freshly isolated mammalian primary hepatocytes and/or a specific hepatoma cell line; and
comparing the calculated TC_{50 specific hepatic} and TC_{50 general hepatic} values, wherein if TC_{50 specific hepatic} is less than TC_{50 general hepatic}, the indication is hepatic toxicity.

18. The method of claim 17, further comprising the step of comparing at least one of the TC_{50 specific hepatic} and TC_{50 general hepatic} values to a maximum therapeutic plasma concentration (Cₘₐₓ) for the chemical compound.

19. The method of claim 17, further comprising the step of comparing at least one of the TC_{50 specific hepatic} and TC_{50 general hepatic} values to a database of chemical compounds that have known levels of hepatic toxicity.

20. The method of claim 17, wherein the TC_{50 specific hepatic} and TC_{50 general hepatic} values are determined by a method comprising the steps of:
providing at least one of freshly isolated mammalian primary hepatocytes and a specific hepatoma cell line;
culturing said cells in the presence of a plurality of concentrations of the chemical compound;
measuring at least one indicator of hepatic specific cell health at the plurality of concentrations of said chemical compound;
performing a concentration response analysis for the at least one indicator of hepatic specific cell health from the measurements obtained at the plurality of concentrations of the chemical compound;
identifying from the concentration response analysis the highest concentration of said chemical compound at which no measurable toxic effect was observed for the at least one indicator of hepatic specific cell health;
determining a concentration that produces a half maximal toxic effect (TC_{50 specific hepatic}) for the at least one indicator of hepatic specific cell health;
measuring at least one indicator of general cell health at the plurality of concentrations of said chemical compound;
performing a concentration response analysis for the at least one indicator of general cell health from the measurements obtained at the plurality of concentrations of the chemical compound;
identifying from the concentration response analysis the highest concentration of said chemical compound at which no measurable toxic effect was observed for the at least one indicator of general cell health; and
determining a concentration that produces a half maximal toxic effect (TC_{50 general hepatic}) for the at least one indicator of general cell health.

21. The method of claim 20, wherein the primary hepatocytes/cell line are specific to the species in which the toxicity determination is required.

22. The method of claim 20, wherein the primary hepatocytes are obtained from rat, dog, monkey or human.

23. The method of claim 20, wherein the hepatoma cell line is selected from the group consisting of the H4IIE cell line and the HepG2 cell line.

24. The method of claim 20, wherein the at least one indicator of hepatic specific cell health is selected from the group consisting of liver specific endpoints for cholestasis, biochemical markers for cell health, key metabolic components, and normal hepatic metabolic functions.

25. The method of claim 24, wherein the at least one indicator of hepatic specific cell health is selected from the group consisting of BSEP, UGT1A1, GGT, ATP, MTT, JC-1, CYP1A, 3A and 4A expression levels, and combinations thereof.

26. The method of claim 20, wherein the general indicators of cell health are selected from the group consisting of indicators of cell membrane integrity, oxidative stress, cell mortality, mitochondrial function, cell proliferation, lysosomal toxicity, and combinations thereof.

27. The method of claim 26, wherein the general indicators of cell health are selected from the group consisting of GGT, AP, ALT, AST, LDH, GST, DCFDA, caspase 3, caspase 8, caspase 9, a BAX/Bcl1 ratio, MTT, ATP, BrdU, and combinations thereof.

28. A method of screening multiple organs for specific organ toxicity, comprising the steps of:
determining a TC₅₀ value for a first organ (TC_{50 organ A})
determining a TC₅₀ value for a second organ (TC_{50 organ B}); and
calculating a toxicity index (TI) as a ratio of TC_{50 organ A}/TC_{50 organ B}, wherein when the TI is equal to 1.0, there is no organ specificity, when the TI is <1.0, the indication is organ A toxicity, and when the TI is >1.0, the indication is organ B toxicity.

29. The method of claim 28, wherein the second organ (organ B) is liver.

30. A method of screening multiple organs for specific organ toxicity, comprising the steps of:
determining a TC₅₀ value for a first organ (TC_{50 organ A}) determining a TC₅₀ value for a second organ (TC_{50 organ B});
determining a TC₅₀ value for a third organ (TC_{50 organ C}); and
calculating a first toxicity index (TI1) as a ratio of TC_{50 organ A}/TC_{50 organ C};
calculating a second toxicity index (TI2) as a ratio of TC_{50 organ B}/TC_{50 organ C}; and
wherein when the ratio of at least one of TI1 and TI2 is about 1.0, there is no organ specificity, when the TI is >1.0, the indication is organ C toxicity, when the TI1 is <1.0, the indication is organ A toxicity, and when TI2 is >1.0, the indication is organ B toxicity.

31. The method of claim 30, wherein the third organ (organ C) is liver.
